(19) United States
(12) Patent Application Publication
(10) Pub. No.: US 2024/0011165 A1
(43) Pub. Date: Jan. 11, 2024

(54) Carbon Oxide Electrolyzer Integrated with Electrical Network

(71) Applicant: Twelve Benefit Corporation, Berkeley, CA (US)

(72) Inventors: Nicholas H. FLANDERS, San Francisco, CA (US); Enrique CINTRON, Brooklyn, NY (US)

(21) Appl. No.: 18/295,412

(22) Filed: Apr. 4, 2023

Related U.S. Application Data
(60) Provisional application No. 63/328,706, filed on Apr. 7, 2022.

(51) Int. Cl. C25B 1/23; C25B 5/00; C10G 2/00; C25B 15/08

(52) U.S. Cl. CPC C25B 1/23; C25B 5/00; C10G 2/34; C25B 15/081

(57) ABSTRACT

Systems and methods may utilize excess electrical energy produced by an electrical network. An example system includes a carbon dioxide electrolyzer configured to electrochemically reduce carbon dioxide to a carbon dioxide reduction product; a vessel configured to store the carbon dioxide reduction product; and an energy conversion device configured to chemically convert the carbon dioxide reduction product and produce electrical energy. The system may be configured to supply electrical energy produced by the energy conversion device to the electrical network. The system may be configured to provide electrical energy from the electrical network to the carbon dioxide electrolyzer.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in their entireties and for all purposes.

### BACKGROUND

Intermittent energy sources such as many renewable energy sources pose a challenge to large electrical networks such as grids that supply electricity customers who frequently need electricity at times when such energy sources have low or no output.

Background and contextual descriptions contained herein are provided solely for the purpose of generally presenting the context of the disclosure. Much of this disclosure presents work of the inventors, and simply because such work is described in the background section or presented as context elsewhere herein does not mean that such work is admitted prior art.

### SUMMARY

Aspects of this disclosure pertain to systems for utilizing excess electrical energy produced by an electrical network, which systems may be characterized by the following features: (a) a carbon dioxide electrolyzer configured to electrochemically reduce carbon dioxide to a carbon dioxide reduction product; (b) a vessel configured to store the carbon dioxide reduction product; and (c) an energy conversion device configured to chemically convert the carbon dioxide reduction product and produce electrical energy. Such systems may be further configured to (i) supply electrical energy produced by the energy conversion device to the electrical network, and (ii) provide electrical energy from the electrical network to the carbon dioxide electrolyzer.

In certain embodiments, a system additionally includes a source of carbon dioxide coupled to the carbon dioxide electrolyzer. The source of carbon dioxide may include a storage vessel configured to store carbon dioxide at a pressure greater than atmospheric pressure.

In certain embodiments, the system is configured to transport carbon dioxide produced by the energy conversion device to a storage vessel for carbon dioxide.

In certain embodiments, the energy conversion device comprises a combustion system, which may comprise a turbine. In certain embodiments, the energy conversion device comprises a fuel-cell configured to electrochemically convert the carbon dioxide reduction product and thereby produce the electrical energy.

In certain embodiments, the carbon dioxide reduction product comprises carbon monoxide. In such embodiments, the system may be configured to combine hydrogen with the carbon monoxide and provide a mixture of carbon dioxide and hydrogen to the energy conversion device. In some implementations, the mixture of carbon dioxide and hydrogen is a syngas. In some implementations, the energy conversion device comprises a Fischer Tropsch reactor configured to convert the syngas to one or more liquid hydrocarbons. In some implementations, the system additionally includes a storage vessel for the liquid hydrocarbons.

Any combination of the above features may be implemented together in system aspects of this disclosure.

Aspects of this disclosure pertain to methods of utilizing excess electrical energy produced by an electrical network, which methods may be characterized by the following operations: (a) receiving electrical energy from the electrical network and using the received electrical energy to electrochemically reduce carbon dioxide to a carbon dioxide reduction product; (b) storing the carbon dioxide reduction product in a vessel; (c) chemically converting the carbon dioxide reduction product and thereby producing electrical energy; and (d) supplying the produced electrical energy to the electrical network.

In certain embodiments, a method additionally includes supplying the carbon dioxide from a source of carbon dioxide to the carbon dioxide electrolyzer. The source of carbon dioxide may include a storage vessel configured to store carbon dioxide at a pressure greater than atmospheric pressure.

In certain embodiments, a method further comprises transporting carbon dioxide produced by chemically converting the carbon dioxide reduction product to a storage vessel for carbon dioxide.

In certain embodiments, chemically converting the carbon dioxide reduction product comprises combusting the carbon dioxide reduction product. In some implementations, combusting the carbon dioxide reduction product is performed in a turbine. In certain embodiments, chemically converting the carbon dioxide reduction product comprises electrochemically converting the carbon dioxide reduction product in a fuel cell.

In certain embodiments, the carbon dioxide reduction product comprises carbon monoxide. In such embodiments, a method may additional include combining hydrogen with the carbon monoxide and using a mixture of carbon dioxide and hydrogen when chemically converting the carbon dioxide reduction product. In some embodiments, the mixture of carbon dioxide and hydrogen is a syngas. In some such embodiments, chemically converting the carbon dioxide reduction product comprises performing a Fischer Tropsch reaction to produce one or more liquid hydrocarbons. In some embodiments, a method additionally includes storing the liquid hydrocarbons in a storage vessel.

Any combination of these operations may be implemented using any features of the apparatus aspects of this disclosure.

These and other features of the disclosure will be presented in more detail below, and in some cases, with reference to the associated drawings.

### BRIEF DESCRIPTION OF THE DRAWINGS

FIG. 1 depicts components of an example system that integrates a carbon dioxide electrolyzer and an electrical network.

FIG. 2 depicts charging components of the FIG. 1 system in more detail.

FIG. 3 depicts discharging components of the FIG. 1 system in more detail.

FIG. 4 depicts an example system for a carbon oxide reduction reactor that may include a cell comprising an MEA (membrane electrode assembly).

FIG. 5 depicts an example MEA for use in COₓ reduction. The MEA has a cathode layer and an anode layer separated by an ion-conducting polymer layer.

### DETAILED DESCRIPTION

### Introduction and Context

This disclosure relates to systems and methods that integrate a carbon dioxide electrolyzer with an electrical network such as a grid. One application of the integration is load leveling the electrical network. In some cases, leveling is appropriate when an electrical network relies on an intermittent source of electrical energy such as electrical energy from solar and/or wind sources.

During periods when more energy is available to an electrical network than is consumed from the network, an electrolyzer-network integrated system may be said to “charge.” As with a battery, the system charges by converting electrical energy to chemical potential energy. Conversely, when more energy is consumed from the electrical network than is otherwise available to the electrical system, the electrolyzer-network integrated system may be said to “discharge” by converting stored chemical energy to electrical energy, which may be provided to the electrical system.

In some configurations, a carbon dioxide electrolyzer is configured to produce a carbon-containing product such as carbon monoxide, methane, ethene, or a combination thereof. In some configurations, a carbon dioxide electrolyzer is configured to produce hydrogen along with a carbon-containing product. In some embodiments, the electrolyzer-network integrated system is configured to convert stored carbon-containing product and optionally hydrogen to electrical energy by combusting the carbon-containing product and optional hydrogen. In some embodiments, the electrolyzer-network integrated system is configured to convert stored carbon-containing product and optionally hydrogen to electrical energy by electrochemical reaction(s) in, e.g., a fuel cell.

In certain embodiments, the components of an electrolyzer-network integrated system include an electrical network such as an electrical grid, a carbon dioxide electrolyzer, an energy conversion device for converting carbon monoxide or other product of the carbon dioxide electrolyzer to electrical energy, a storage component for the carbon monoxide or other product of the carbon dioxide electrolyzer, and, optionally, one or more pressure regulating components. In some implementations, an electrolyzer-network integrated system includes a system for recycling and storing carbon dioxide produced by the energy conversion device. In such implementations, stored carbon dioxide may be made available as an input to the carbon dioxide electrolyzer during “charging.”

In some embodiments, during charging, the carbon dioxide electrolyzer produces oxygen from water at the electrolyzer' s anode. Such oxygen may be stored for later use during discharging. Such later use may involve supplying oxygen along with a carbon-containing reduction product (e.g., CO) and optionally hydrogen to a combustion engine and/or supplying these materials to a fuel cell.

Storage of carbon dioxide and carbon monoxide is typically easier and less expensive than the storage of hydrogen. Therefore, integrated systems of this disclosure that employ carbon oxide electrolyzers often compare favorably to integrated systems that rely entirely on hydrogen from, e.g., water electrolyzers.

To address climate change and other threats, governments sometimes incentivize through tax credits or other means utilizing carbon dioxide and/or producing hydrogen. Governments also sometimes incentivize making electricity available to grids during periods of peak demand. Certain embodiments disclosed herein match with some or all of these incentives.

Challenges and opportunities remain for integrating such reactors with electrical networks such as grids. Such challenges include preparing carbon dioxide streams from various sources for electrolysis, controlling operation of electrolyzers to effectively use such carbon dioxide to produce appropriate chemical products, and incorporating one or more such chemical products into energy flows suitable for load leveling.

Further, electrolytic carbon dioxide reactors must balance various operating conditions such as reactant composition at the anode and cathode, electrical energy delivered to the anode and cathode, and the physical chemical environment of the electrolyte, anode, and cathode. Balancing these conditions can have a strong impact on the electrolytic reactor's operating voltage, Faradaic yield, and mix of products generated at the cathode, including carbon monoxide (CO), and/or other carbon-containing products (CCPs), and hydrogen.

### Terminology

Unless defined otherwise, all technical and scientific terms used herein have the same meaning as commonly understood by one of ordinary skill in the art. The terms presented immediately below may be more fully understood by reference to the remainder of the specification. The following descriptions are presented to provide context and an introduction to the complex concepts described herein. These descriptions are not intended to limit the full scope of the disclosure.

As used herein, the term “carbon oxide” includes carbon dioxide (CO₂), carbon monoxide (CO), carbonate ions (CO₃²⁻), bicarbonate ions (HCO₃⁻), and any combinations thereof.

A “mixture” contains two or more components and unless otherwise stated may contain components other than the identified components.

An “electrical network” includes a collection of conductive paths such as wires configured to transmit, distribute, and optionally generate electrical power. An example of an electrical network is a “grid.” An electrical grid is usually understood to be a system configured to provide electricity from its generation to the customers that use it. Modern grids include both small local systems as well as much more expansive systems that may stretch thousands of kilometers and connect thousands to millions of users such as homes and businesses. A grid may employ substations and/or other distribution nodes to facilitate delivery of generated electricity to end users.

An “energy conversion device” is an apparatus that converts energy from one form to another form. For example, an energy conversion device may convert chemical energy and/or thermal energy to electrical energy. In various embodiments herein, an energy conversion device is configured to chemically convert the carbon dioxide reduction product and produce electrical energy. Examples of such energy conversion devices include combustion devices and fuel cells.

In some embodiments, a combustion device is configured to combust a fuel and convert energy generated by combustion of the fuel to electrical energy. In some embodiments, a combustion device includes a component that converts energy from combustion to mechanical energy such as by reciprocating and/or rotational motion. Examples of combustion devices include engines and turbines.

A “storage device” is a container or containment region that can hold a material such as a gas or liquid such as carbon dioxide, carbon monoxide, oxygen, hydrogen, or mixture containing any one of these. In some embodiments, a storage device is a vessel configured to hold a gas or liquid at a pressure higher than ambient or local pressure. A storage device may contain a metal or ceramic wall or chamber. In some embodiments, a storage device includes natural or geological structures such as salt domes and aging oil fields.

### Electrolyzer Integration Example Configurations

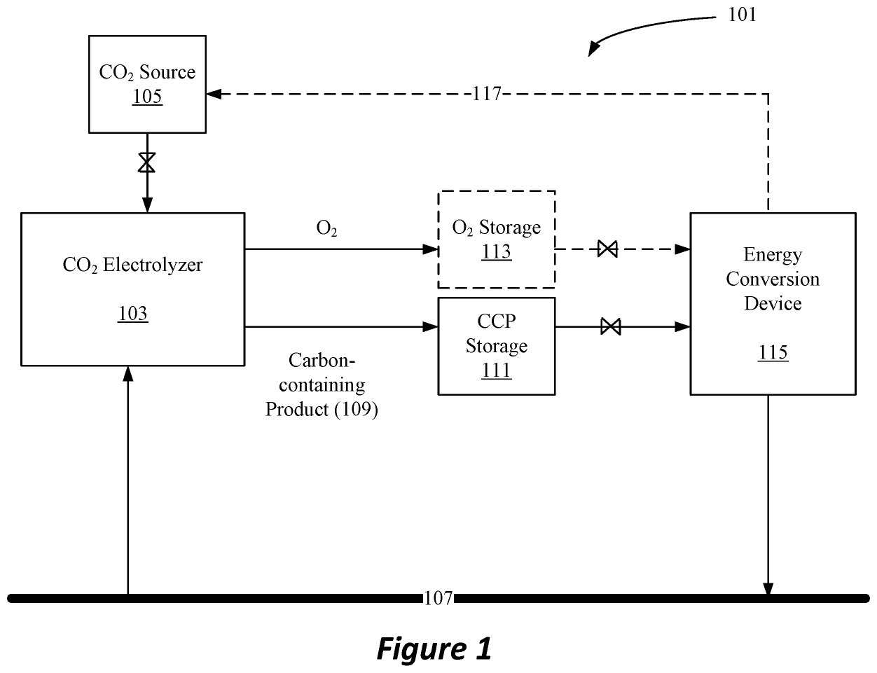

FIG. 1 presents an example of an electrolyzer-network integrated system 101 that integrates a carbon dioxide electrolyzer with an electrical network, such as an electrical grid. In the depicted embodiment, a carbon dioxide electrolyzer 103 receives carbon dioxide from a carbon dioxide source 105. Carbon dioxide electrolyzer 103 is electrically connected to electrical network 107 in a manner that allows electrolyzer 103 to receive sufficient electrical energy to reduce carbon dioxide from carbon dioxide source 105 to an electrolyzer product 109. In various embodiments, electrolyzer product 109 is a carbon-containing product such as carbon monoxide and/or an organic compound such as methane, ethene, etc. Electrolyzer product 109 may be produced by reducing carbon dioxide at a cathode of electrolyzer 103. Electrolyzer 103 may additionally produce oxygen as an oxidation product of water at the anode of the electrolyzer.

As depicted, the system includes storage vessels 111 and 113 for the carbon dioxide reduction product and oxygen, respectively. In some embodiments, oxygen is not employed by the integration system, and in such cases, oxygen storage vessel 113 need not be present. In such cases, oxygen produced by electrolyzer 103 may simply be vented or may be stored or transported for sale or other use.

System 101 includes a chemical energy conversion device 115 coupled to the carbon dioxide reduction product storage vessel 111 and optionally to the oxygen storage vessel 113.

During periods when insufficient energy is generated by an intermittent power source or when electrical energy can otherwise be utilized by the electrical network 107, the carbon dioxide reduction product and optionally oxygen are provided to electrical energy generating device 115 which converts the carbon dioxide reduction product through, e.g., a chemical oxidation process, to electrical energy which can be supplied back to the electrical network 107. In certain embodiments, energy conversion component 115 is or comprises a combustion chamber and associated electricity generating engine or turbine. In some embodiments, component 115 is a fuel cell.

In some embodiments, operation of device 115 produces carbon dioxide and optionally other products. In certain embodiments, system 101 is configured to provide carbon dioxide to carbon dioxide source 105 via, e.g., an optional recycle path 117, which may include a carbon dioxide purification unit (not shown).

In certain embodiments, carbon dioxide source 105 comprises a storage vessel configured to hold pressurized carbon dioxide. Similarly, in certain embodiments, either or both of storage vessel 111 and 113 for the carbon dioxide reduction product and oxygen, respectively, may be configured to hold pressurized gas or liquid.

During periods when excess energy is generated by an intermittent power source or when electrical energy is otherwise available from the electrical network 107, network 107 may supply electrical energy to carbon dioxide electrolyzer 103 to convert carbon dioxide from source 105 to the carbon dioxide reduction product and optionally oxygen, which may be stored in storage vessels 111 and 113.

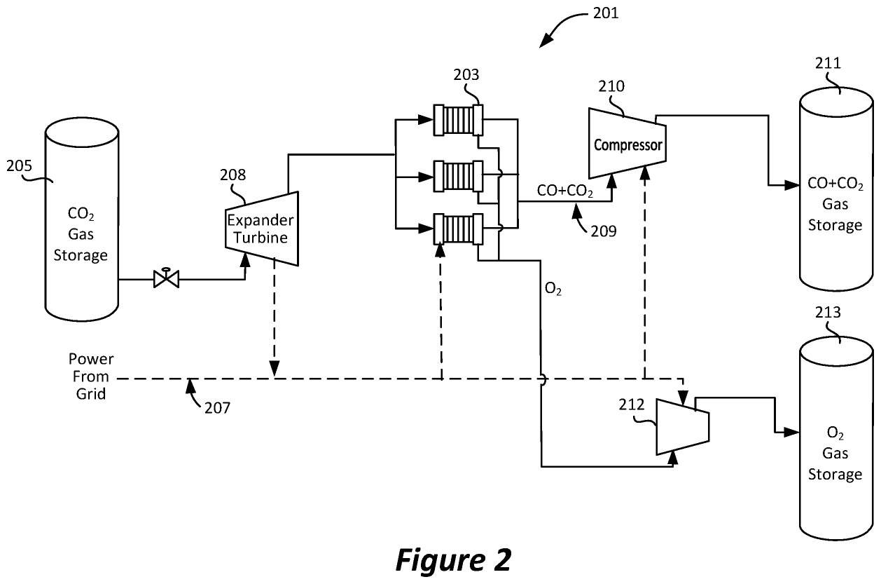

FIG. 2 provides an example, of a “charging” subsystem 201 of an electrolyzer-network integrated system. As depicted, a carbon dioxide storage vessel 205 holds previously collected carbon dioxide, optionally collected from an energy conversion device during “discharging.”

During “charging” subsystem 201 causes carbon dioxide from vessel 205 to be delivered to a carbon dioxide electrolyzer system 203, which may comprise one or more electrolyzer stacks. Because carbon dioxide in vessel 205 may be pressurized, subsystem 201 may be configured to reduce the gas pressure before carbon dioxide is supplied to electrolyzer system 203. To this end, subsystem 201 may include an expander turbine 208 configured to reduce the pressure of carbon dioxide from vessel 205. In some embodiments, mechanical energy from turbine 208 is converted to electrical energy and supplied to an electrical network 207 such as an electrical grid.

Electrical energy from electric network 207 is available to carbon dioxide electrolyzer system 203 to electrochemically reduce carbon dioxide and produce a carbon-containing reduction product 209. In the depicted embodiment, such product comprises carbon monoxide along with some unreacted carbon dioxide. Subsystem 201 may be configured to store product 209 for later use during “discharging.” To this end, subsystem 201 may include a compressor 210 configured to pressurize product 209 and pass the pressurized product to a pressure vessel 211. As depicted, subsystem 201 may be configured to provide electrical energy from network 207 to compressor 210.

As indicated, carbon dioxide electrolyzers may produce oxygen gas as an output. In embodiments utilizing oxygen for discharge operations, subsystem 201 may be configured to receive oxygen from electrolyzer 203, pressurize such oxygen, and store it in a pressure vessel 213. To this end, subsystem 201 may include a compressor 212 and provisions to provide electrical energy from network 207 to drive compressor 212. Pressurized oxygen from compressor 212 may be conveyed to vessel 213.

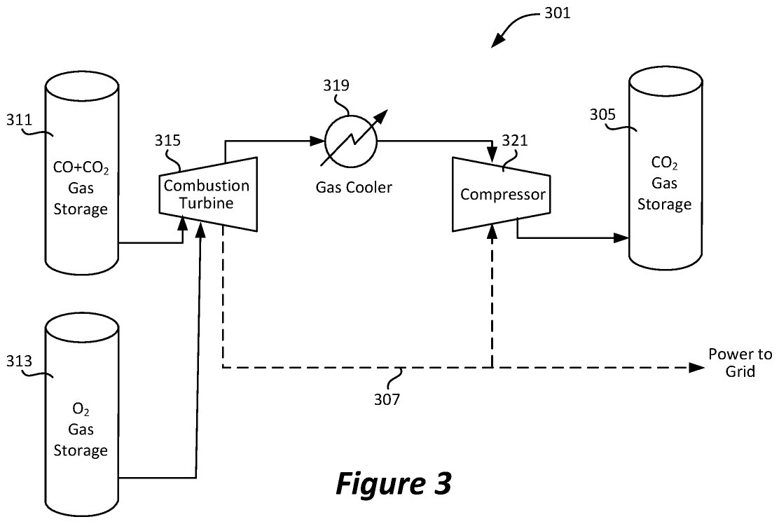

FIG. 3 provides an example, of a “discharging” subsystem 301 of an electrolyzer-network integrated system. As depicted, a carbon-containing reduction product storage vessel 311 holds, e.g., previously generated carbon monoxide along with some unreacted carbon dioxide. Also, an optional oxygen storage vessel 313 holds previously generated oxygen. These components may have been generated by a carbon dioxide electrolyzer during a “charging” phase.

Subsystem 301 includes an energy conversion device such as a combustion turbine 315 configured to react the carbon-containing reduction product from vessel 311 and optionally oxygen from vessel 313 to produce electrical energy, which is delivered to an electrical network 307 such as an electrical grid.

Subsystem 301 includes an optional gas cooler 319 configured to receive combustion products, typically including carbon dioxide gas, from turbine 315 and cool these products before further use. While not depicted, subsystem 301 may additionally include one or more components for purifying such carbon dioxide.

Subsystem 301 also includes a compressor 321 located downstream from cooler 319 for pressurizing carbon dioxide prior to storage. Compressor 321 may be electrically coupled to network 307 to receive electrical power to drive compression of the carbon dioxide.

Subsystem 301 additionally includes a carbon dioxide storage vessel 305 located downstream from compressor 321. Vessel 305 is configured to receive and store pressurized carbon dioxide before it is used by a carbon dioxide electrolyzer during a “discharge” phase.

Note that while the systems depicted in FIGS. 1-3 employ components for processing, pressurizing, and storing carbon dioxide produced by an energy conversion device, some embodiments do not employ such components. Some embodiments of an electrolyzer-network system comprise carbon dioxide electrolyzers that receive carbon dioxide from another source such as directly from air or from an industrial plant that generates carbon dioxide as a byproduct. Examples of such industrial plants include cement producing factories, fossil fuel burning power plants, steel making factories, and the like.

### Integration Components

### Carbon Oxide Electrolyzer Inputs

In general, an integrated system as disclosed herein can employ any form of carbon oxide electrolyzer, not necessarily one that reduces only carbon dioxide. In general, a carbon oxide electrolyzer may receive a carbon oxide that originates from any of various sources. Examples include air or other ambient gas, combustion device output gases, and factory output such as output from a cement plant or a steelmaking plant. In some embodiments, a carbon oxide for an electrolyzer may be recycled from a chemical reaction of a carbon-containing product of a carbon oxide electrolyzer.

Common examples of carbon oxide reactants are carbon dioxide and carbon monoxide, typically though not necessarily in gaseous form. Other examples of carbon oxide reactant include carbonate, and/or bicarbonate compounds. In certain embodiments, a carbonate or bicarbonate is provided in the form of an aqueous solution (e.g., an aqueous solution of potassium bicarbonate) that can be delivered to the cathode of a reduction cell. Carbonates and bicarbonates may be obtained from various sources (e.g., minerals) and/or by various reactions (e.g., reacting carbon dioxide with hydroxide). While most discussion herein pertains to carbon dioxide as the reactant for the electrolyzer, it should be understood that other carbon oxides may replace or supplement carbon dioxide as an electrolyzer reactant in some embodiments.

An upstream source of carbon dioxide may be connected directly to an input of a carbon dioxide electrolyzer (e.g., serves as the input, such as connected to the reduction catalyst via the cathode flow field and/or gas diffusion layer, etc.) or alternatively the upstream source may be connected to a purification system; a gas compression system; or both a purification system and a gas compression system, in either order; which then connect to an input of a carbon dioxide system of the disclosure. One or more purification and/or gas compression systems (e.g., scrubbers, purifiers, etc.) may be employed. As indicated, the source of carbon dioxide may come from an energy conversion device such as a combustion turbine that burns a carbon-containing fuel and produces electrical energy for an electrical system such as an electrical grid.

The carbon dioxide provided as input to a carbon oxide electrolyzer integrated with an electrical network may, depending on the construction and operating conditions of the electrolyzer, have a range of concentrations. In certain embodiments, carbon dioxide provided to a carbon dioxide electrolyzer has a concentration of at least about 20 mole percent, or at least about 40 mole percent, or at least about 75 mole percent, or at least about 90 mole percent. In certain embodiments, carbon dioxide provided to a carbon dioxide reduction reactor has a concentration of about 40 to 60 mole percent.

An upstream source of water for a carbon oxide electrolyzer integrated with an electrical network may come from any of various sources and in various forms such as purified tap water, purified sea water, a byproduct of direct air capture of water, optionally with capture of carbon dioxide, combustion processes that may also produce carbon dioxide feedstock, fuel cell byproduct, and the like. In certain embodiments, water for a carbon oxide electrolyzer includes some salt such as potassium or bicarbonate, potassium or sodium hydroxide, and the like.

### Carbon Oxide Electrolyzer Outputs

An electrolyzer and electrical network system may include components for capturing, conveying, storing, and/or utilizing one or more outputs of a carbon oxide electrolyzer in a downstream system. Such outputs may include a carbon-containing product and/or oxygen produced by a carbon oxide electrolyzer. Such outputs may include unreacted carbon oxide and/or unreacted water. A carbon oxide reactor output of the disclosure may be directly connected (e.g., via the cathode flow field and/or gas diffusion layer) to a downstream system, and/or the carbon dioxide reactor output may be connected to a purification system; a gas compression system; or both a purification system and a gas compression system, in either order; which then optionally connect to an input of a downstream system and/or to one or more storage devices. Multiple purification systems and/or gas compression systems may be employed. In various embodiments, a carbon-containing product and/or oxygen produced by a carbon oxide electrolyzer is provided to a storage vessel for the carbon-containing product and/or a storage vessel for the oxygen.

A carbon dioxide electrolyzer integrated with an electrical network may be configured, designed, and/or controlled in a manner that allows the electrolyzer to produce one or more carbon dioxide electrolysis products in a quantity, concentration, and/or ratio suitable for generating electrical energy for the electrical network.

A carbon dioxide electrolyzer can make a range of suitable products (for example, methane, ethene, carbon monoxide (CO), molecular hydrogen (H₂), ethane, and oxygen) that can be used in downstream systems and processes such as combustion turbines or other electrical energy generating devices. Carbon monoxide is a notable example; it can be used alone and or in combination with hydrogen to form syngas. In certain embodiments, a carbon oxide electrolyzer is configured to produce a hydrocarbon such as methane or ethene which may be combusted and/or utilized by fuel-cell to generate electrical energy.

Different carbon dioxide electrolyzers (e.g., including different layer stacks, catalysts and/or catalyst layers, PEMs, flow fields, gas diffusion layers, cell compression configurations, and/or any other suitable aspects, etc.) can be used to produce different reduction products; however, different reduction products can additionally or alternatively be produced by adjusting the operation parameters, and/or be otherwise achieved.

An integrated electrolyzer-network system may include a connection between a carbon dioxide containing output of an energy conversion device (e.g., a combustion turbine or fuel cell) and an input of a carbon dioxide electrolyzer. The carbon dioxide containing output of a downstream system may be connected to a purification system, a gas compression system, or both a purification system and a gas compression system, in either order, which then connect to an input of a carbon dioxide reactor of the disclosure. Multiple purification systems and/or gas compression systems may be employed. The carbon dioxide containing output may be stored in a storage vessel.

### Electrical Networks

As indicated, an integrated system may include an electrical network as a source of electrical energy for operating a carbon dioxide electrolyzer, compressor, and/or another component. The source of electrical energy to the electrical network may include a solar electrical energy production system, a wind electrical energy production system, a geothermal electrical energy production system, a fossil fuel electrical energy production system, a nuclear power plant, a hydroelectric system, or any other system capable of electrical energy production. Any such system may be used alone or in combination to produce electrical energy to power operation of the one or more electrolyzers.

A carbon dioxide electrolyzer and integrated components may be employed to store electrical energy in the form of chemical energy. For example, power producers may produce excess power during off-peak usage periods. Integrated systems containing carbon oxide reduction reactors are able to respond quickly to a need to consume excess power. They do not need to warm up to operate, and they can be cycled between power on and power off states without deterioration of carbon dioxide reactors. The ability to respond quickly to power utilization needs allows systems to work well with intermittent sources of power such as solar electrical energy production systems, and wind electrical energy production systems.

For many applications, energy consumers require electrical energy having a particular voltage range and having a particular electrical waveform. Such results can be achieved if an integration system employs appropriate electronic components such as rectifiers and transformers. These components may be provided between an electrical network and an energy conversion device.

Similarly, a carbon oxide reduction electrolyzer or stack may require electrical energy in a particular form such as DC energy. If such an electrolyzer or stack receives electrical energy directly from an electrical network, it may require that the electrical energy be rectified and transformed such as by a rectifier, a transformer, and/or other electrical components. Similarly, a compressor in an integration system may require energy from an electrical network be modified prior to delivery to the compressor.

### Storage Devices

As indicated, an integrated carbon dioxide electrolyzer and electric network may employ one or more storage devices. Examples of such devices include pressure vessels. Other examples, include natural or geological features such as salt domes and aging oil fields.

As indicated, an integration system may employ a storage device that stores one or more reduction products of a carbon dioxide electrolyzer cathode (e.g., carbon monoxide, methane, ethene) optionally along with unreacted carbon dioxide. In some cases, an integration system may employ a storage device that stores an oxidation products of a carbon dioxide electrolyzer anode (e.g., oxygen) optionally along with unreacted water. In some cases, an integration system may employ a storage device that stores one or more products of an energy conversion device such as carbon dioxide.

In certain embodiments, carbon dioxide for use in a carbon oxide electrolyzer is stored in the form of a bicarbonate or carbonate. Such bicarbonate or carbonate may be stored or provided as a solution (e.g., an aqueous solution), a suspension, and/or a solid. In some embodiments, carbon dioxide produced by an energy conversion device is converted to a carbonate or bicarbonate for storage, prior to being supplied to a carbon oxide electrolyzer. Such conversion may involve contacting gaseous carbon dioxide with water or other solvent, optionally with a base such as hydroxide ion.

In certain embodiments, a carbon dioxide electrolyzer is located and operated in a high-pressure environment such as a salt dome or aging oil field, which contains pressurized carbon dioxide. Such embodiments may have the benefit of not requiring that carbon dioxide from the carbon dioxide source be decompressed prior to providing to the electrolyzer. Such embodiments may not require a separate storage vessel (other than the high-pressure environment) for the carbon dioxide.

### Energy Conversion Devices

As indicated, an integrated system may employ any of various types of energy conversion devices for converting carbon monoxide, syngas, methane, or other product of the carbon dioxide electrolyzer to electrical energy. Examples of combustion devices include turbines and engines as well as fired heaters and steam boiler systems.

As indicated, an integrated system may employ a fuel cell as an energy conversion device. In such embodiments, electrolyzer products may be electrochemically consumed in a fuel cell to directly produce electrical power. In certain embodiments, a carbon oxide electrolyzer output such as carbon monoxide or methanol is stored for later use in a fuel cell to directly inject electrical energy back into an electrical network. In certain embodiments, the fuel cell is a fuel cell configured to oxidize carbon-containing reactants (e.g., natural gas) such as a solid oxide fuel cell from Bloom Energy of Sunnyvale, CA.

### Liquid Hydrocarbon Producing Reactors

In certain embodiments, an integrated system including a carbon dioxide electrolyzer includes a Fischer-Tropsch reactor configured to produce light liquid hydrocarbons. While such embodiments may require an additional component, e.g., a Fischer-Tropsch reactor, they have the benefit of more easily storing the carbon dioxide electrolyzer reduction product because that product is a liquid and need not be compressed. In some implementations, system 201 of FIG. 2 may be modified to include a Fischer-Tropsch reactor between compressor 210 and storage unit 211.

In various embodiments, the input stream to a Fischer-Tropsch reactor is about 1:2 molar ratio of CO:H₂. A carbon dioxide electrolyzer may not produce gas having the required approximately 1:2 molar ratio of CO:H₂for a Fischer-Tropsch feed. In some cases, a carbon dioxide electrolyzer produces a CO-rich stream. Therefore, in some embodiments, a Fischer-Tropsch system, a methanol production system, or any other system that requires a carbon monoxide and hydrogen mixture, may employ a water electrolyzer or other source of hydrogen that optionally works in conjunction with the carbon dioxide electrolyzer. The water electrolyzer is configured to make gaseous hydrogen to supplement the CO-rich output of the carbon dioxide electrolyzer. In some embodiments, syngas that is relatively rich in hydrogen can be produced as part of co-electrolysis of carbon dioxide and water.

Alternatively, a single carbon dioxide electrolyzer can be used to produce a more suitable Fischer-Tropsch CO and H₂ feed blend. This can be accomplished by operating the electrolyzer in a way that biases the output toward hydrogen production and/or by processing the electrolyzer output to adjust its composition prior to delivery to the Fischer-Tropsch reactor.

The output of a carbon dioxide electrolyzer may contain product carbon monoxide, byproduct hydrogen, unreacted carbon dioxide, and water vapor. The system may be configured to remove the water vapor and separate the unreacted carbon dioxide. A gas separation unit may be used to separate the carbon dioxide from the carbon monoxide and hydrogen and/or otherwise concentrate the carbon monoxide and hydrogen. The system may include a recycle loop to recycle water to a water inlet of a carbon dioxide or water electrolyzer. The unreacted and separated carbon dioxide is then compressed and returned to the inlet of the carbon dioxide electrolyzer.

A F-T reactor may operate at about 300 psi or greater and between about 150-300° C. If the output of a carbon dioxide electrolyzer and optional water electrolyzer is not at the required pressure, the system may employ a compressor to bring up the feed gas pressure before entering the F-T reactor. In the F-T reactor, the CO-H₂ mixture is converted into raw F-T liquid and waxes. A system may include a separator following the F-T reactor to separate water, high melting point F-T liquid, medium melting point F-T liquid, and tail gas, a mixture of volatile hydrocarbons, CO₂, CO, and H₂. The F-T liquid may be further upgraded via hydrocracking. Distillation and separation of different fractions of the F-T liquid may result in jet fuel, diesel, and gasoline. Water from the F-T reactor can be filtered to remove impurities and fed to a water input of the CO₂ and/or optional water electrolyzers.

A F-T system may be designed so that tail gas and/or volatile hydrocarbons (e.g., including methane) are recycled back to the CO₂ electrolyzer. The system may be configured to separate the tail gas into CO₂, which may be compressed and fed directly to the electrolyzer inlet and volatile hydrocarbons and unreacted CO and H₂. The system may be designed or configured such that these products are fed to a combustion reactor (e.g., an energy conversion device) to generate heat, electrical energy, and CO₂. The CO₂ is then stored for later use by the CO₂ electrolyzer. The O₂ from the electrolyzer may be used as the oxygen source for combustion, resulting in a relatively pure CO₂ output stream. The combustion reactor may be run in “rich burn” mode utilizing an excess of fuel to oxygen to minimize the concentration of oxygen in the outlet stream. Water from the combustion reaction may be separated from the gas output and can be fed to the water input of the CO₂ electrolyzer or water electrolyzer.

Because a Fischer Tropsch reaction is exothermic, it produces heat that may be used for other purposes in a system. Examples of such other uses include separations (e.g., distillation of light hydrocarbons) and reactions. In conventional systems, such reactions are endothermic reactions for production of syngas such as reforming of fossil fuels, gasification of biomass, or production from carbon dioxide and hydrogen via reverse water gas shift. Hence, in conventional processing, all or a significant portion of the excess heat from a Fischer Tropsch reaction is typically directed to the syngas production. In the present case, however, which produces syngas at a low temperature (e.g., less than about 100° C.) by processes such as carbon dioxide electrolysis optionally along with low temperature water electrolysis, there is more excess heat from the Fischer-Tropsch reaction available for other processes, thereby reducing the overall external heat requirement of the system and improving carbon and energy efficiency of the carbon dioxide to fuel synthesis pathway.

In some embodiments, tail gas is fed to a reformer where methane or other gaseous hydrocarbons react with water to produce a mixture of hydrogen and carbon monoxide, a form of syngas. This may increase the yield of carbon from carbon dioxide in a liquid hydrocarbon product. Depending on the composition of tail gas, the ratio of hydrogen to carbon monoxide may vary. In some embodiments, some amount of carbon dioxide and/or oxygen is present in a reformer. In many cases, the reforming reaction is endothermic. In some embodiments, heat to drive the endothermic reaction is provided, at least in part, from excess heat generated during the Fischer-Tropsch reaction. In some cases, some heat may be provided by combustion or direct electrical energy. For combustion-derived heat, oxygen (optionally from an electrolyzer) may be fed to the furnace to improve efficiency, and carbon dioxide emissions could be captured and stored for later use by the electrolyzer.

While the term Fischer Tropsch is used herein, it should be understood to cover any of a class of reactions and reactors that produce a light hydrocarbon liquid such as naphtha from an input containing carbon monoxide and hydrogen. Generally, such reactions are exothermic.

Additional details of Fischer Tropsch reactors and their integration with carbon dioxide electrolyzers may be found in PCT application Publication No. 2022031726, published Feb. 10, 2022, which is incorporated herein by reference in its entirety.

### Sources of Hydrogen

In some embodiments, hydrogen is used together with carbon monoxide as syngas for conversion to electrical energy in a combustion device or a fuel cell. In some embodiments, hydrogen is used together with carbon monoxide as syngas for conversion to light liquid hydrocarbons in a Fischer-Tropsch reactor. In certain integration embodiments, hydrogen can be obtained from various sources such as a byproduct of the reduction reaction in a carbon dioxide electrolyzer. It can also be obtained via the use of one or more water electrolyzers in combination with the carbon dioxide electrolyzers.

### Pressure Regulating Components

As illustrated in FIGS. 2 and 3, an integration system may include one or more pressure regulating components such as compressors and expansion turbines.

Compressors may be used to pressurize products such as anode and cathode outputs from electrolyzers and/or energy conversion device byproducts such as carbon dioxide. The pressurized products may be stored in respective pressurized storage devices for later use. Compressors may also be used for pressurizing certain inputs to integration system components such as syngas supplied to a Fischer-Tropsch reactor. Compressors may be connected in an integrated system such that they receive electrical energy from an electrical network. Compressors may be of any type conventionally used to pressurize gas for industrial applications.

While high pressure may be appropriate for storing materials, it may be not be suitable for operating some system components such as electrolyzers. Therefore, expansion turbines or similar elements may be used to depressurize inputs such as pressurized carbon dioxide prior to inlet to a carbon dioxide electrolyzer. Expansion turbines may be configured to generate electrical energy while depressurizing a gas. In this regard, an expansion turbine may be connected to an integrated system in a manner allowing the turbine to provide electrical energy to an electrical network. Expansion turbines may be of any type conventionally used to depressurize gas for industrial applications.

### Recycle of carbon dioxide

As indicated, an energy conversion device such as a combustion reactor may produce carbon dioxide, which is in turn made available as an input reactant to a carbon dioxide electrolyzer. In various embodiments, carbon dioxide produced by an energy conversion device is stored in a storage device such as a pressure vessel for a period before it is made available to the carbon dioxide electrolyzer. The energy conversion device produces carbon dioxide during discharge and the carbon dioxide electrolyzer consumes the carbon dioxide during charging. In such approaches, carbon dioxide may be said to be “recaptured” from a chemical energy conversion device. Such systems may alternately generate and consume carbon dioxide without significant loss to the atmosphere.

Systems that recapture carbon dioxide in this manner and employ a combustion device as the energy conversion device may employ oxygen or other concentrated oxidant as opposed to air. This is because nitrogen from the air would be in the product stream from the combustion device and would need to be somehow separated from the carbon dioxide in the product stream so that additional compression resources and energy are not required to compress the nitrogen which is effectively inert in the overall process. In other words, an integrated system may be designed or configured such that oxygen from the electrolyzer is used as the oxygen source for combustion, resulting in a relatively pure carbon dioxide output stream. In certain embodiments, the combustion reactor may be run in a “rich burn” mode utilizing an excess of fuel to oxygen to minimize the concentration of oxygen in the outlet stream. Water from the combustion reaction may be separated from the gas output and can be fed to the water input of the carbon dioxide electrolyzer or water electrolyzer.

In some embodiments, the energy conversion device is not a combustion reactor but rather a fuel cell such as a solid oxide fuel cell. Methane, carbon monoxide, hydrogen, and/or other cathode reduction products of a carbon dioxide electrolyzer may be provided as “fuel” to a fuel cell, which in turn oxidizes such fuel and thereby produces electrical energy and some carbon dioxide. The resulting carbon dioxide may be temporarily stored and then subsequent provided as an input to the carbon dioxide electrolyzer. Such embodiments need not employ a storage device or other components for recovering and storing oxygen produced by a carbon oxide electrolyzer.

In some embodiments, carbon dioxide produced by an energy conversion device may be converted to a carbonate or bicarbonate for storage as a solution, a suspension, and/or a solid.

### Carbon Oxide Electrolyzer Design and Operating Conditions

A carbon oxide electrolyzer' s design and operating conditions can be tuned for particular applications. Often this involves designing or operating the electrolyzer in a manner that produces a cathode output having specified compositions. In some implementations, one or more general principles may be applied to operate in a way that produces a required output stream composition.
1. Restrict carbon dioxide reactant availability at the cathode active sites and/or increase current density at the cathode. These operating condition ranges tend to produce the following results: (a) initially, upon decreasing the carbon dioxide reactant availability and/or increasing the current density, the fraction of CO₂ converted to CO increases (i.e., CO:CO₂ in the output stream increases); (b) at some point, upon further decreasing the carbon dioxide reactant availability and/or increasing the current density, the hydrogen ion reduction reaction becomes more pronounced (i.e., the ratio of H₂:CO increases). Electrolyzers that can operate with relatively little carbon dioxide input/availability may have flow fields or gas diffusion components that restrict carbon dioxide from reaching active sites on the electrolyzer cathode. In certain embodiments, flow field designs that are not interdigitated, and such flow field designs that have long paths such as serpentine paths between the source of CO₂ and the cathode result in higher ratios of CO:H₂. Interdigitated flow field forces input gas (carbon oxide) to flow through the gas diffusion layer before exiting at a different location on the flow field. Non-interdigitated designs have long continuous paths for the carbon oxide feed gas to flow into and out of the cathode. Channels on the inlet side are spaced from the channels on the outlet side. In certain embodiments, gas diffusion electrodes that are relatively thick restrict CO₂ mass transport to the cathode active sites and therefor tend to increase the ratio of CO:CO₂ and/or H₂:CO.

2. Make hydrogen ions relatively more available at the cathode. Making hydrogen ions relatively more available at the cathode may produce a cathode product stream with a relatively high ratio of H₂:CO. Electrolyzers configured in a way that provides a relatively hydrogen rich product may employ designs that (a) starve the cathode of carbon dioxide reactant (as described in 1), (b) permit a relatively high flux of hydrogen ions to be transported from the anode, where they are generated, to the cathode, and/or (c) operate at a relatively high cell temperature. Electrolyzers that can operate with a relatively high flux of hydrogen ions to the cathode may have MEAs with cation conducting polymers and/or mixed ion conducting polymers at the cathode. Alternatively or additionally, in MEAs including a cathode buffer layer, the layer may be relatively thin and/or have a relatively high hydrogen ion transference number.

3. Make hydrogen ions less available at the cathode. Making hydrogen ions relatively more less at the cathode may produce a cathode product stream with relatively high ratios of CO:H₂. Electrolyzers configured in a way that provides a relatively hydrogen poor product may employ designs that (a) provide the cathode with surplus carbon dioxide reactant for a given current density, (b) contain MEA designs that prevent hydrogen ions from reaching the cathode, and/or (c) operate at a relatively low cell temperature.

High CO₂ Reduction Product (Particularly CO) to CO₂ Ratio Operating Parameter Regime

In certain embodiments, an electrolyzer is configured to produce, and when operating actually produce, an output stream having a CO:CO₂ molar ratio of at least about 1:1 or at least about 1:2 or at least about 1:3. A high CO output stream may alternatively be characterized as having a CO concentration of at least about 25 mole %, or at least about 33 mole %, or at least about 50 mole %.

In certain embodiments, this high carbon monoxide output concentration is obtained by operating a carbon dioxide electrolyzer in a manner that produces any one of or any combination of the following operating conditions:
a current density of at least about 300 mA/cm², at the cathode,
a CO₂ stoichiometric flow rate (as described elsewhere herein) of at most about 4, or at
most about 2.5, or at most about 1.5,
a temperature of at most about 80° C. or at most about 65° C.,
a pressure range of about 75 to 400 psig,
an anode water composition of about 0.1 to 50 mM bicarbonate salt, and
an anode water pH of at least about 1.

In certain embodiments, the electrolyzer may be built to favor high CO:CO₂ molar ratios or concentrations, as defined here, by using a carbon dioxide electrolyzer having any one of or any combination of the following properties:
relatively small nanoparticle cathode catalysts (e.g., having largest dimensions of, on average, about 0.1-15 nm),
gold as the cathode catalyst material,
a cathode catalyst layer thickness of about 5-20 um,
a cathode gas diffusion layer (GDL) with a microporous layer (MPL),
a cathode GDL with PTFE present at about 1-20 wt %, or about 1-10 wt %, or about 1-5 wt %,
a GDL that has a thickness of at least about 200 um,
a bipolar MEA having an anion-exchange cathode buffer layer having a thickness of at least about 5 um, and
a cathode flow field having parallel and/or serpentine flow paths.
   High reduction product (H₂+CO) to CO₂ ratio operating parameter regime

In certain embodiments, an electrolyzer is configured to produce, and in operation actually produces, an output stream having a (H₂+CO):CO₂ molar ratio of at least about 2:1 or at least about 1:2 or at least about 1:3.

In certain embodiments, this high reduction product output concentration is obtained by operating a carbon dioxide electrolyzer in a manner that produces any one of or any combination of the following operating conditions:
a current density of at least about 300 mA/cm²,
a CO₂ stoichiometric flow rate of at most about 4, or at most about 2.5, or at most about 1.5,
a temperature of at most about 125° C.,
a pressure of at most about 800 psi,
anode water composition of 0 to about 500 mM bicarbonate salt, and
an anode water pH of about 0-15.

In certain embodiments, the electrolyzer may be built to favor high (CO+H₂):CO₂ molar ratios or concentrations, as defined here, by using a carbon dioxide electrolyzer having any one of or any combination of the following properties:
nanoparticle cathode catalysts (e.g., having a largest dimension, on average, of about 0.1-1000 nm),
a transition metal as a cathode catalyst material,
a cathode catalyst layer thickness of about 0.1-100 um,
a cathode gas diffusion layer with or without a microporous layer (MPL),
a GDL with about 0-70 wt % PTFE,
a GDL that is about 10-1000 um thick, and
a bipolar MEA having an anion-exchange cathode buffer layer that is about 0-100 um thick.

### Hydrogen Rich Product Stream Operating Parameter Regime

In certain embodiments, a carbon dioxide electrolyzer is configured to produce, and when operating actually produces, an output stream having H₂:CO in a molar ratio of at least about 1:1.

In certain embodiments, such hydrogen rich output concentration is obtained by operating a carbon dioxide electrolyzer in a manner that produces any one of or any combination of the following operating conditions:
a current density of at least about 300 mA/cm²,
a CO₂ mass transfer stoichiometric flow rate to the cathode of up to about 2,
a temperature of at least about 65° C. or at least about 80 ° C.,
a pressure range of about 75 to 500 psig,
an anode water composition of pure water or at least about50 mM bicarbonate salt, and
an anode water pH of at most about 1.

In certain embodiments, the electrolyzer may be built to favor hydrogen rich molar ratios or concentrations, as defined here, by using a carbon dioxide electrolyzer having any one of or any combination of the following properties:

relatively large nanoparticle cathode catalysts (e.g., having a largest dimension of, on average, at least about 80 nm)
silver, palladium, or zinc as the cathode catalyst material,
a cathode catalyst layer thickness of at most about 5 um or a thickness of at least about 25 um,
a cathode gas diffusion layer with no microporous layer (MPL),
a cathode GDL with no PTFE present or at least about 20 wt % PTFE,
a cathode GDL having a thickness that is at most about 200 um or at least about 500 um, and
a bipolar MEA having an anion-exchange cathode buffer layer with a thickness that is about 0-5 um.

### High Reduction Product to Hydrogen Product Stream Operating Parameter Regime

In certain embodiments, a carbon dioxide electrolyzer is configured to produce, and when operating actually produces, an output stream having CO:H₂ in a molar ratio of at least about 2:1.

In certain embodiments, such product rich output concentration is obtained by operating a carbon dioxide electrolyzer in a manner that produces any one of or any combination of the following operating conditions:
a current density at the cathode of at least about 300 mA/cm²,
a CO2 mass transfer stoichiometric flow rate to the cathode of at least about 1.5, or at least about 2.5, or at least about 4,
a temperature of at most about 80° C.,
a pressure in the range of about 75 to 400 psig,
an anode water composition of about 0.1 mM to 50 mM bicarbonate salt, and
an anode water pH of greater than about 1.

In certain embodiments, the electrolyzer may be built to favor product-rich molar ratios or concentrations, as defined here, by using a carbon dioxide electrolyzer having any one of or any combination of the following properties:
relatively small nanoparticle catalysts (e.g., having largest dimensions of, on average, about 0.1-15 nm),
gold as the cathode catalyst material,
a cathode catalyst layer thickness of about 5-20 um,
a cathode gas diffusion layer with a microporous layer (MPL),
a cathode GDL with PTFE present at about 1-20 wt %, or about 1-10 wt %, or about 1-5 wt %,
a cathode GDL that has a thickness of at least about 200 um, and
a bipolar MEA having an anion-exchange layer with a thickness of at least about 5um.

### Hydrocarbon Reduction Product

In energy conversion processes that require methane and/or ethene inputs, a carbon oxide electrolyzer may be designed to favor production of these hydrocarbons. In some embodiments, the electrolyzer cathode employs a transition metal such as copper as a reduction catalyst. See for example PCT Patent Application Publication No. 2020/146402, published Jul. 16, 2020, and titled “SYSTEM AND METHOD FOR METHANE PRODUCTION,” which is incorporated herein by reference in its entirety. Electrolysis systems for producing ethene may be configured to recycle some hydrocarbon product of a carbon oxide electrolyzer back to the cathode and/or provide two more electrolyzers operating in series, with the cathode output of a first electrolyzer feeding the input to a cathode of a second electrolyzer. See for example PCT Patent Application No. PCT/US2021/036475, filed Jun. 8, 2021, and titled “SYSTEM AND METHOD FOR HIGH CONCENTRATION OF MULTIELECTRON PRODUCTS OR CO IN ELECTROLYZER OUTPUT,” which is incorporated herein by reference in its entirety.

### Stoichiometric Flow Rate

Given that a molar flow rate may be determined, at least in part, by the electrical current delivered to the cell, the molar flow rate may be tied to the current. As an example, the molar flow rate of carbon oxide in the input stream may be defined in terms of flow rate per unit of reaction expected for a given current. Herein, the term “stoichiometric” flow rate refers to a fraction or multiple of the flow rate of reactant carbon oxide required to fully utilize all current at the cathode, assuming that the reduction reaction of carbon oxide is 100% efficient at the cathode to a given reaction. A flow rate of carbon oxide having a stoichiometric value of “1” is the flow rate required to consume all electrons provided at the cathode, and no more than that, in the given reduction reaction at the cathode. Stated another way, the stoichiometric flow rate is the amount of excess (or shortfall) reactant that is present beyond (or below) what could be theoretically reacted if the current efficiency for a given reaction were 100%.

For the carbon dioxide reduction reaction that produces carbon monoxide in an acidic environment (CO₂+2H++2e−→CO+H₂O), a carbon dioxide flow rate with a stoichiometric value of 1 provides one mole of carbon dioxide for every two moles of electrons provided by the cell. Stated another way, a cell having a current providing 2 moles of electrons/second and a carbon dioxide flow rate providing 1 mole of carbon dioxide molecules/second would have a stoichiometric flow rate of 1. For the same current and a flow rate of 0.5 carbon dioxide moles/second, the cell would have a stoichiometric flow rate of 0.5. And, again for the same current but with a flow rate of 1.5 carbon dioxide moles/second, the cell would have a stoichiometric flow rate of 1.5. The molar flow rate needed to achieve a stoichiometric flow rate of 1 can be calculated:

Stoichiometric Flow Rate (sccm)=[60 (s/min)*Molar gas volume at STP (mL/mol)]/[Faraday's constant (C/mol e−)*#e−'s/mole CO₂]*Amps of current fed to the electrolyzer

Total amps of current can be calculated from the current density, the area of the electrolyzer cell and the number of cells in the electrolyzer:

Amps of current=current density*area of the electrolyzer cell*number of cells

In an example, a 100 cm² electrolyzer with a current density of 500 mA/cm² performing the electrochemical reduction of CO₂ to CO has a total current of 50A and the reaction requires 2 moles of e−/mole CO produced, so the stoichiometric flow rate of 1 is:

[60*22,413]/[9,6485*2]*50=348.4 sccm

In this example a stoichiometric flow rate of 0.5 would be:

0.5*348.4=174.2 sccm

And a stoichiometric flow rate of 2 is:

2*348.4=696.8 sccm

In another example of a cell producing ethylene from carbon dioxide, 12 moles of electrons are needed to reduce 2 moles of carbon dioxide to 1 mole of ethylene. The stoichiometric flow rate for a 3 cell 1500 cm² electrolyzer with a current density of 300 mA/cm² is:

[60*22,413]/[96,485*6]*1350=3,136 sccm.

### Carbon Oxide Electrolyzer Embodiments

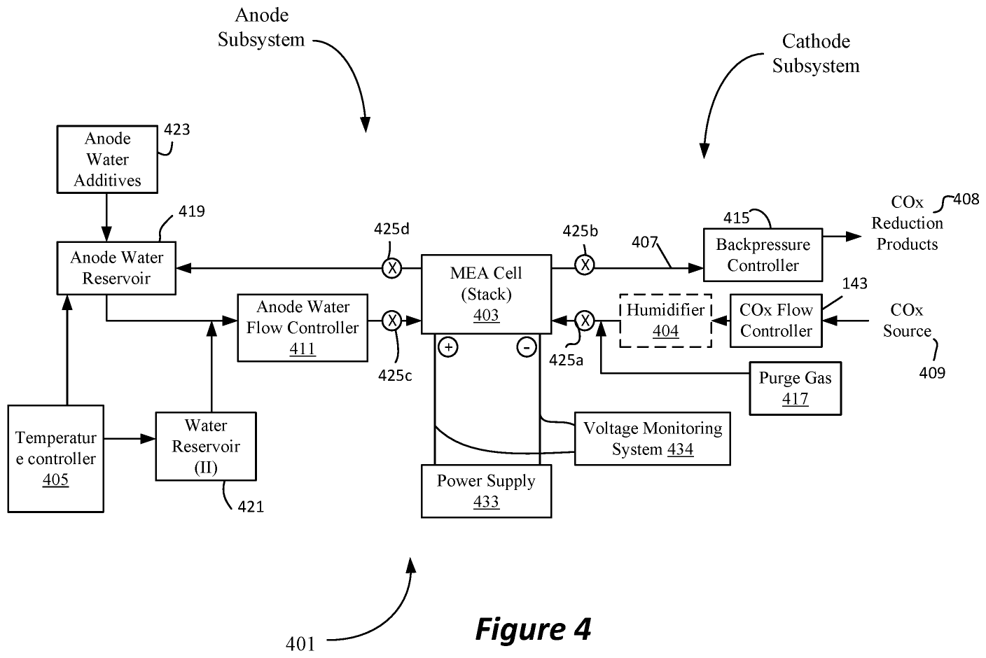

FIG. 4 depicts an example system 401 for a carbon oxide reduction reactor 403 that may include a cell comprising a MEA (membrane electrode assembly). The reactor may contain multiple cells or MEAs arranged in a stack. System 401 includes an anode subsystem that interfaces with an anode of reduction reactor 403 and a cathode subsystem that interfaces with a cathode of reduction reactor 403. System 401 is an example of a system that may be used with or to implement any of the methods or operating conditions described above.

As depicted, the cathode subsystem includes a carbon oxide source 409 configured to provide a feed stream of carbon oxide to the cathode of reduction reactor 403, which, during operation, may generate an output stream that includes product(s) of a reduction reaction at the cathode. The product stream may also include unreacted carbon oxide and/or hydrogen. See 408.

The carbon oxide source 409 is coupled to a carbon oxide flow controller 413 configured to control the volumetric or mass flow rate of carbon oxide to reduction reactor 403. One or more other components may be disposed on a flow path from flow carbon oxide source 409 to the cathode of reduction reactor 403. For example, an optional humidifier 404 may be provided on the path and configured to humidify the carbon oxide feed stream. Humidified carbon oxide may moisten one or more polymer layers of an MEA and thereby avoid drying such layers. Another component that may be disposed on the flow path is a purge gas inlet coupled to a purge gas source 417. In certain embodiments, purge gas source 417 is configured to provide purge gas during periods when current is paused to the cell(s) of reduction reactor 403. In some implementations, flowing a purge gas over an MEA cathode facilitates recovery of catalyst activity and/or selectivity. Examples of purge gases include carbon dioxide, carbon monoxide, hydrogen, nitrogen, argon, helium, oxygen, and mixtures of any two or more of these.

During operation, the output stream from the cathode flows via a conduit 407 that connects to a backpressure controller 415 configured to maintain pressure at the cathode side of the cell within a defined range (e.g., about 50 to 800 psig, depending on the system configuration). The output stream may provide the reaction products 408 to one or more components (not shown) for separation and/or concentration.

In certain embodiments, the cathode subsystem is configured to controllably recycle unreacted carbon oxide from the outlet stream back to the cathode of reduction reactor 403. In some implementations, the output stream is processed to remove reduction product(s) and/or hydrogen before recycling the carbon oxide. Depending upon the MEA configuration and operating parameters, the reduction product(s) may be carbon monoxide, hydrogen, hydrocarbons such as methane and/or ethylene, oxygen-containing organic compounds such as formic acid, acetic acid, and any combinations thereof. In certain embodiments, one or more components, not shown, for removing water from the product stream are disposed downstream form the cathode outlet. Examples of such components include a phase separator configured to remove liquid water from the product gas stream and/or a condenser configured to cool the product stream gas and thereby provide a dry gas to, e.g., a downstream process when needed. In some implementations, recycled carbon oxide may mix with fresh carbon oxide from source 409 upstream of the cathode.

As depicted in FIG. 4, an anode subsystem is configured to provide an anode feed stream to an anode side of the carbon oxide reduction reactor 403. In certain embodiments, the anode subsystem includes an anode water source, not shown, configured to provide fresh anode water to a recirculation loop that includes an anode water reservoir 419 and an anode water flow controller 411. The anode water flow controller 411 is configured to control the flow rate of anode water to or from the anode of reduction reactor 403. In the depicted embodiment, the anode water recirculation loop is coupled to components for adjusting the composition of the anode water. These may include a water reservoir 421 and/or an anode water additives source 423. Water reservoir 421 is configured to supply water having a composition that is different from that in anode water reservoir 419 (and circulating in the anode water recirculation loop). In one example, the water in water reservoir 421 is pure water that can dilute solutes or other components in the circulating anode water. Pure water may be conventional deionized water even ultrapure water having a resistivity of, e.g., at least about 15 MOhm-cm or over 18.0 MOhm-cm. Anode water additives source 423 is configured to supply solutes such as salts and/or other components to the circulating anode water.

During operation, the anode subsystem may provide water or other reactant to the anode of reactor 403, where it at least partially reacts to produce an oxidation product such as oxygen. The product along with unreacted anode feed material is provided in a reduction reactor outlet stream. Not shown in FIG. 4 is an optional separation component that may be provided on the path of the anode outlet stream and configured to concentrate or separate the oxidation product from the anode product stream.

Other control features may be included in system 401. For example, a temperature controller may be configured to heat and/or cool the carbon oxide reduction reactor 403 at appropriate points during its operation. In the depicted embodiment, a temperature controller 405 is configured to heat and/or cool anode water provided to the anode water recirculation loop. For example, the temperature controller 405 may include or be coupled to a heater and/or cooler that may heat or cool water in anode water reservoir 419 and/or water in reservoir 421. In some embodiments, system 401 includes a temperature controller configured to directly heat and/or cool a component other than an anode water component. Examples of such other components in the cell or stack and the carbon oxide flowing to the cathode.

Depending upon the phase of the electrochemical operation, including whether current is paused to carbon oxide reduction reactor 403, certain components of system 401 may operate to control non-electrical operations. For example, system 401 may be configured to adjust the flow rate of carbon oxide to the cathode and/or the flow rate of anode feed material to the anode of reactor 403. Components that may be controlled for this purpose may include carbon oxide flow controller 413 and anode water controller 411.

In addition, depending upon the phase of the electrochemical operation including whether current is paused, certain components of system 401 may operate to control the composition of the carbon oxide feed stream and/or the anode feed stream. For example, water reservoir 421 and/or anode water additives source 423 may be controlled to adjust the composition of the anode feed stream. In some cases, additives source 423 may be configured to adjust the concentration of one or more solutes such as one or more salts in an aqueous anode feed stream.

In some cases, a temperature controller such controller 405 is configured to adjust the temperature of one or more components of system 401 based on a phase of operation. For example, the temperature of cell 403 may be increased or decreased during break-in, a current pause in normal operation, and/or storage.

In some embodiments, a carbon oxide electrolytic reduction system is configured to facilitate removal of a reduction cell from other system components. This may be useful with the cell needs to be removed for storage, maintenance, refurbishment, etc. In the depicted embodiments, isolation valves 425a and 425b are configured to block fluidic communication of cell 403 to a source of carbon oxide to the cathode and backpressure controller 415, respectively. Additionally, isolation valves 425c and 425d are configured to block fluidic communication of cell 403 to anode water inlet and outlet, respectively.

The carbon oxide reduction reactor 403 may also operate under the control of one or more electrical power sources and associated controllers. See, block 433. Electrical power source and controller 433 may be programmed or otherwise configured to control current supplied to and/or to control voltage applied to the electrodes in reduction reactor 403. The current and/or voltage may be controlled to execute the current schedules and/or current profiles described elsewhere herein. For example, electrical power source and controller 433 may be configured to periodically pause current applied to the anode and/or cathode of reduction reactor 403. Any of the current profiles described herein may be programmed into power source and controller 433.

In certain embodiments, electric power source and controller 433 performs some but not all the operations necessary to implement desired current schedules and/or profiles in the carbon oxide reduction reactor 403. A system operator or other responsible individual may act in conjunction with electrical power source and controller 433 to fully define the schedules and/or profiles of current applied to reduction reactor 403. For example, an operator may institute one or more current pauses outside the set of current pauses programmed into power source and controller 433.

In certain embodiments, the electrical power source and controller acts in concert with one or more other controllers or control mechanisms associated with other components of system 401. For example, electrical power source and controller 433 may act in concert with controllers for controlling the delivery of carbon oxide to the cathode, the delivery of anode water to the anode, the addition of pure water or additives to the anode water, and any combination of these features. In some implementations, one or more controllers are configured to control or operate in concert to control any combination of the following functions: applying current and/or voltage to reduction cell 403, controlling backpressure (e.g., via backpressure controller 415), supplying purge gas (e.g., using purge gas component 417), delivering carbon oxide (e.g., via carbon oxide flow controller 413), humidifying carbon oxide in a cathode feed stream (e.g., via humidifier 404), flow of anode water to and/or from the anode (e.g., via anode water flow controller 411), and anode water composition (e.g., via anode water source 405, pure water reservoir 421, and/or anode water additives component 423).

In the depicted embodiment, a voltage monitoring system 434 is employed to determine the voltage across an anode and cathode of an MEA cell or across any two electrodes of a cell stack, e.g., determining the voltage across all cells in a multi-cell stack. The voltage determined in this way can be used to control the cell voltage during a current pause, inform the duration of a pause, etc. In certain embodiments, voltage monitoring system 434 is configured to work in concert with power supply 433 to cause reduction cell 403 to remain within a specified voltage range. For example, power supply 433 may be configured to apply current and/or voltage to the electrodes of reduction cell 403 in a way that maintains the cell voltage within a specified range during a current pause. If, for example during a current pause, the cell's open circuit voltage deviates from a defined range (as determined by voltage monitoring system 434), power supply may be configured to apply current or voltage to the electrodes to maintain the cell voltage within the specified range.

An electrolytic carbon oxide reduction system such as that depicted in FIG. 4 may employ a control system that includes one or more controllers and one or more controllable components such as pumps, sensors, dispensers, valves, and power supplies. Examples of sensors include pressure sensors, temperature sensors, flow sensors, conductivity sensors, voltmeters, ammeters, electrolyte composition sensors including electrochemical instrumentation, chromatography systems, optical sensors such as absorbance measuring tools, and the like. Such sensors may be coupled to inlets and/or outlets of an MEA cell (e.g., in a flow field), in a reservoir for holding anode water, pure water, salt solution, etc., and/or other components of an electrolytic carbon oxide reduction system.

Among the various functions that may be controlled by one or more controllers are: applying current and/or voltage to a carbon oxide reduction cell, controlling backpressure on an outlet from a cathode on such cell, supplying purge gas to a cathode inlet, delivering carbon oxide to the cathode inlet, humidifying carbon oxide in a cathode feed stream, flowing anode water to and/or from the anode, and controller anode feed composition. Any one or more of these functions may have a dedicated controller for controlling its function alone. Any two or more of these functions may share a controller. In some embodiments, a hierarchy of controllers is employed, with at least one master controller providing instructions to two or more component controllers. For example, a system may comprise a master controller configured to provide high level control instructions to (i) a power supply to a carbon oxide reduction cell, (ii) a cathode feed stream flow controller, and (iii) an anode feed stream flow controller. For example, a programmable logic controller (PLC) may be used to control individual components of the system.

In certain embodiments, a control system is configured to apply current to a carbon oxide reduction cell comprising an MEA in accordance with a current schedule, which may have any of the characteristics described herein. For example, the current schedule may provide periodic pauses in the applied current. In some cases, the control system provides the current pauses with defined profiles such as ramps and/or step changes as described herein.

In certain embodiments, a control system is configured to control the flow rate of one or more feed streams (e.g., a cathode feed stream such as a carbon oxide flow and an anode feed stream) in concert with a current schedule. For example, the flow of carbon oxide or a purge gas may be turned on, turned off, or otherwise adjusted when current applied to an MEA cell is paused.

In certain embodiments, a control system may be configured to implement a recovery sequence as described herein. Such control system may be configured to pause or reduce current, flow a recovery gas, flow water or other liquid, dry the cathode, resume normal operation, or any combination thereof. The controller may be configured to control the initiation of a recovery sequence, control the duration of any operation in a recovery sequence, etc.

A controller may include any number of processors and/or memory devices. The controller may contain control logic such software or firmware and/or may execute instructions provided from another source. A controller may be integrated with electronics for controlling operation the electrolytic cell before, during, and after reducing a carbon oxide. The controller may control various components or subparts of one or multiple electrolytic carbon oxide reduction systems. The controller, depending on the processing requirements and/or the type of system, may be programmed to control any of the processes disclosed herein, such as delivery of gases, temperature settings (e.g., heating and/or cooling), pressure settings, power settings (e.g., electrical voltage and/or current delivered to electrodes of an MEA cell), liquid flow rate settings, fluid delivery settings, and dosing of purified water and/or salt solution. These controlled processes may be connected to or interfaced with one or more systems that work in concert with the electrolytic carbon oxide reduction system.

In various embodiments, a controller comprises electronics having various integrated circuits, logic, memory, and/or software that receive instructions, issue instructions, control operations described herein. The integrated circuits may include chips in the form of firmware that store program instructions, digital signal processors (DSPs), chips defined as application specific integrated circuits (ASICs), and/or one or more microprocessors, or microcontrollers that execute program instructions (e.g., software). Program instructions may be instructions communicated to the controller in the form of various individual settings (or program files), defining operational parameters for carrying out a process on one or more components of an electrolytic carbon oxide reduction system. The operational parameters may, in some embodiments, be part of a recipe defined by process engineers to accomplish one or more processing steps during generation of a particular reduction product such as carbon monoxide, hydrocarbons, and/or other organic compounds.

The controller, in some implementations, may be a part of or coupled to a computer that is integrated with, coupled to the system, otherwise networked to the system, or a combination thereof. For example, the controller may utilize instructions stored remotely (e.g., in the “cloud”) and/or execute remotely. The computer may enable remote access to the system to monitor current progress of electrolysis operations, examine a history of past electrolysis operations, examine trends or performance metrics from a plurality of electrolysis operations, to change parameters of current processing, to set processing steps to follow a current processing, or to start a new process. In some examples, a remote computer (e.g. a server) can provide process recipes to a system over a network, which may include a local network or the internet. The remote computer may include a user interface that enables entry or programming of parameters and/or settings, which are then communicated to the system from the remote computer. In some examples, the controller receives instructions in the form of data, which specify parameters for each of the processing steps to be performed during one or more operations.

The controller may be distributed, such as by comprising one or more discrete controllers that are networked together and working towards a common purpose, such as applying current to an MEA cell and other process controls described herein. An example of a distributed control system for such purposes includes one or more processors on a system for electrolytically reducing a carbon oxide and one or more processors located remotely (such as at the platform level or as part of a remote computer) that combine to control a process.

Controllers and any of various associated computational elements including processors, memory, instructions, routines, models, or other components are sometimes described or claimed as “configured to” perform a task or tasks. In such contexts, the phrase “configured to” is used to denote structure by indicating that the component includes structure (e.g., stored instructions, circuitry, etc.) that performs a task or tasks during operation. As such, a controller and/or associated component can be said to be configured to perform the task even when the specified component is not necessarily currently operational (e.g., is not on).

Controllers and other components that are “configured to” perform an operation may be implemented as hardware—for example, circuits, memory storing program instructions executable to implement the operation, etc. Additionally, controllers and other components “configured to” perform an operation may be implemented as hardware that is manipulated by software and/or firmware (e.g., an FPGA or a general-purpose processor executing software) to operate in manner that is capable of performing the recited task(s). Additionally, “configured to” can refer to one or more memories or memory elements storing computer executable instructions for performing the recited task(s). Such memory elements may include memory on a computer chip having processing logic.

Non-computation elements such as reactors such electrolyzers, membrane assemblies, layers, and catalyst particles may also be “configured” to perform certain functions. In such contexts, the phrase “configured to” indicate that the referenced structure has one or more features that allow the function to be performed. Examples of such features include physical and/or chemical properties such as dimensions, composition, porosity, etc.

### MEA Embodiments

### MEA Overview

In various embodiments, an MEA contains an anode layer, a cathode layer, electrolyte, and optionally one or more other layers. The layers may be solids and/or gels. The layers may include polymers such as ion-conducting polymers.

When in use, the cathode of an MEA promotes electrochemical reduction of COₓ by combining three inputs: COₓ, ions (e.g., protons or hydroxide ions) that chemically react with COₓ, and electrons. The reduction reaction may produce CO, hydrocarbons, and/or hydrogen and oxygen-containing organic compounds such as methanol, ethanol, and acetic acid. When in use, the anode of an MEA promotes an electrochemical oxidation reaction such as electrolysis of water to produce elemental oxygen and protons. The cathode and anode may each contain catalysts to facilitate their respective reactions.

During operation of an MEA, ions move through a polymer-electrolyte, while electrons flow from an anode, through an external circuit, and to a cathode. In some embodiments, liquids and/or gas move through or permeates the MEA layers. This process may be facilitated by pores in the MEA.

The compositions and arrangements of layers in the MEA may promote high yield of a COₓ reduction products. To this end, the MEA may facilitate any one or more of the following conditions: (a) minimal parasitic reduction reactions (non-CO) reduction reactions) at the cathode; (b) low loss of COₓ reactants to the anode or elsewhere in the MEA; (c) physical integrity of the MEA during the reaction (e.g., the MEA layers remain affixed to one another); (d) prevent COₓ reduction product cross-over; (e) prevent oxidation product (e.g., O₂) cross-over; (f) a suitable environment at the cathode for the reduction reaction; (g) a pathway for desired ions to travel between cathode and anode while blocking undesired ions; and (h) low voltage operation.

### COₓ Reduction Considerations

Polymer-based membrane assemblies such as MEAs have been used in various electrolytic systems such as water electrolyzers and in various galvanic systems such as fuel cells. However, COₓ reduction presents problems not encountered, or encountered to a lesser extent, in water electrolyzers and fuel cells.

For example, for many applications, an MEA for COₓ reduction requires a lifetime on the order of about 50,000 hours or longer (approximately five years of continuous operation), which is significantly longer than the expected lifespan of a fuel cell for automotive applications; e.g., on the order of 5,000 hours. And for various applications, an MEA for COₓ reduction employs electrodes having a relatively large surface area by comparison to MEAs used for fuel cells in automotive applications. For example, MEAs for COₓ reduction may employ electrodes having surface areas (without considering pores and other nonplanar features) of at least about 500 cm².

COₓ reduction reactions may be implemented in operating environments that facilitate mass transport of particular reactant and product species, as well as to suppress parasitic reactions. Fuel cell and water electrolyzer MEAs often cannot produce such operating environments. For example, such MEAs may promote undesirable parasitic reactions such as gaseous hydrogen evolution at the cathode and/or gaseous CO₂ production at the anode.

In some systems, the rate of a COₓ reduction reaction is limited by the availability of gaseous COₓ reactant at the cathode. By contrast, the rate of water electrolysis is not significantly limited by the availability of reactant: liquid water tends to be easily accessible to the cathode and anode, and electrolyzers can operate close to the highest current density possible.

### MEA Configurations

In certain embodiments, an MEA has a cathode layer, an anode layer, and a polymer electrolyte membrane (PEM) between the anode layer and the cathode layer. The polymer electrolyte membrane provides ionic communication between the anode layer and the cathode layer, while preventing electronic communication, which would produce a short circuit. The cathode layer includes a reduction catalyst and, optionally, an ion-conducting polymer (sometimes called an ionomer). The cathode layer may also include an electron conductor and/or an additional ion conductor. The anode layer includes an oxidation catalyst and, optionally, an ion-conducting polymer. The anode layer may also include an electron conductor and/or an additional ion conductor. The PEM also includes an ion-conducting polymer. In certain embodiments, the MEA has a cathode buffer layer between the cathode layer and the polymer electrolyte membrane. The cathode buffer also includes an ion-conducting polymer.

The ion-conducting polymers in the PEM, the cathode, the anode, and the cathode buffer layer, if present, may each be different from one another in composition, conductivity, molecular weight, or other property. In some cases, two or more of these polymers are identical. For example, the ion-conducting polymer in the cathode and cathode buffer layer may be identical.

In certain embodiments, the MEA has an anode buffer layer between the anode layer and the polymer electrolyte membrane. The anode buffer also includes an ion-conducting polymer, which may have the same properties as any of the other ion-conducting polymers (e.g., the ion-conducting polymer in the anode). Or, the ion-conducting layer of the anode may be different from every other ion-conducting layer in the MEA.

In connection with certain MEA designs, there are three available classes of ion-conducting polymers: anion-conductors, cation-conductors, and mixed cation-and-anion-conductors. In certain embodiments, at least two of the first, second, third, fourth, and fifth ion-conducting polymers are from different classes of ion-conducting polymers.

### Ion-Conducting Polymers for MEA Layers

The term “ion-conducting polymer” or “ionomer” is used herein to describe a polymer that conducts ions (anions and/or cations) is to say that the material is an ion-conducting material or ionomer. In certain embodiments, an MEA contains one or more ion-conducting polymers having a specific conductivity of about 1 mS/cm or greater for anions and/or cations. The term “anion-conductor” describes an ion-conducting polymer that conducts anions primarily (although there will still be some small amount of cation conduction) and has a transference number for anions greater than about 0.85 at around 100 micrometers thickness. The terms “cation-conductor” and/or “cation-conducting polymer” describe an ion-conducting polymer that conducts cations primarily (e.g., there can still be an incidental amount of anion conduction) and has a transference number for cations greater than approximately 0.85 at about 100 micrometers thickness. For an ion-conducting polymer that is described as conducting both anions and cations (a “cation-and-anion-conductor”), neither the anions nor the cations have a transference number greater than approximately 0.85 or less than approximately 0.15 at about 100 micrometers thickness. Examples of ion-conducting polymers of each class are provided in the below Table 1.

Ion-Conducting Polymers

| Class | Description | Common Features | Examples |
|---|---|---|---|
| A. | Greater than | Positively charged | aminated tetramethyl |
| Anion- | approximately 1 | functional groups | polyphenylene; |
| conducting | mS/cm specific | are covalently | poly(ethylene-co- |
| | conductivity for | bound to the | tetrafluoroethylene)- |
| | anions, which have a | polymer backbone | based quaternary |
| | transference number | | ammonium polymer; |
| | greater than | | quaternized polysulfone |
| | approximately 0.85 | | |
| | at | | |
| | around 100 | | |
| | micron | | |
| | thickness | | |
| B. | Greater than | Salt is soluble in | polyethylene oxide; |
| Conducts | approximately 1 | the polymer and | polyethylene glycol; |
| both | mS/cm conductivity | the salt ions can | poly(vinylidene |
| anions and | for ions (including | move through the | fluoride); polyurethane |
| cations | both cations and | polymer material | |
| | anions), which have a | | |
| | transference number | | |
| | between | | |
| | approximately | | |
| | 0.15 and 0.85 at | | |
| | around 100 micron | | |
| | thickness | | |
| C. | Greater than | Negatively | perfluorosulfonic acid |
| Cation- | approximately 1 | charged functional | polytetrafluoroethylene |
| conducting | mS/cm specific | groups are | co-polymer; |
| | conductivity for | covalently bound | sulfonated poly(ether |
| | cations, which have a | to the polymer | ketone); |
| | transference number | backbone | poly(styrene sulfonic |
| | greater than | | acid-co-maleic acid) |
| | approximately 0.85 | | |
| | at | | |
| | around 100 | | |
| | micron | | |
| | thickness | | |

### Polymeric Structures

Examples of polymeric structures that can include an ionizable moiety or an ionic moiety and be used as ion-conducting polymers (ionomers) in the MEAs described here are provided below. The ion-conducting polymers may be used as appropriate in any of the MEA layers that include an ion-conducting polymer. Charge conduction through the material can be controlled by the type and amount of charge (e.g., anionic and/or cationic charge on the polymeric structure) provided by the ionizable/ionic moieties. In addition, the composition can include a polymer, a homopolymer, a copolymer, a block copolymer, a polymeric blend, other polymer-based forms, or other useful combinations of repeating monomeric units. As described below, an ion conducting polymer layer may include one or more of crosslinks, linking moieties, and arylene groups according to various embodiments. In some embodiments, two or more ion conducting polymers (e.g., in two or more ion conducting polymer layers of the MEA) may be crosslinked.

Non-limiting monomeric units can include one or more of the following:

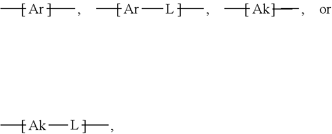

in which Ar is an optionally substituted arylene or aromatic; Ak is an optionally substituted alkylene, haloalkylene, aliphatic, heteroalkylene, or heteroaliphatic; and L is a linking moiety (e.g., any described herein) or can be —C(R⁷)(R⁸)—. Yet other non-limiting monomeric units can include optionally substituted arylene, aryleneoxy, alkylene, or combinations thereof, such as optionally substituted (aryl)(alkyl)ene (e.g., -Ak-Ar- or -Ak-Ar-Ak- or -Ar-Ak-, in which Ar is an optionally substituted arylene and Ak is an optionally substituted alkylene). One or more monomeric units can be optionally substituted with one or more ionizable or ionic moieties (e.g., as described herein).

One or more monomeric units can be combined to form a polymeric unit. Non-limiting polymeric units include any of the following:

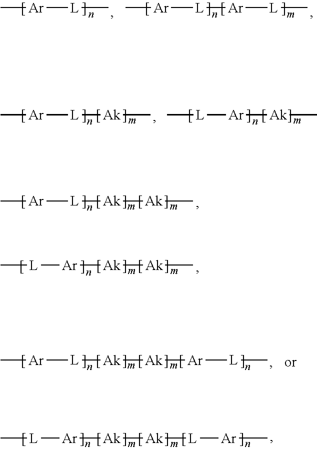

in which Ar, Ak, L, n, and m can be any described herein. In some embodiments, each m is independently 0 or an integer of 1 or more. In other embodiments, Ar can include two or more arylene or aromatic groups.

Other alternative configurations are also encompassed by the compositions herein, such as branched configurations, diblock copolymers, triblock copolymers, random or statistical copolymers, stereoblock copolymers, gradient copolymers, graft copolymers, and combinations of any blocks or regions described herein.

Examples of polymeric structures include those according to any one of formulas (I)-(V) and (X)-(XXXIV), or a salt thereof. In some embodiments, the polymeric structures are copolymers and include a first polymeric structure selected from any one of formulas (I)-(V) or a salt thereof; and a second polymeric structure including an optionally substituted aromatic, an optionally substituted arylene, a structure selected from any one of formulas (I)-(V) and (X)-(XXXIV), or a salt thereof.

In one embodiment, the MW of the ion-conducting polymer is a weight-average molecular weight (Mw) of at least 10,000 g/mol; or from about 5,000 to 2,500,000 g/mol. In another embodiment, the MW is a number average molecular weight (Mn) of at least 20,000 g/mol; or from about 2,000 to 2,500,000 g/mol.

In any embodiment herein, each of n, n1, n2, n3, n4, m, m1, m2, or m3 is, independently, 1 or more, 20 or more, 50 or more, 100 or more; as well as from 1 to 1,000,000, such as from 10 to 1,000,000, from 100 to 1,000,000, from 200 to 1,000,000, from 500 to 1,000,000, or from 1,000 to 1,000,000.

Non-limiting polymeric structures can include the following:

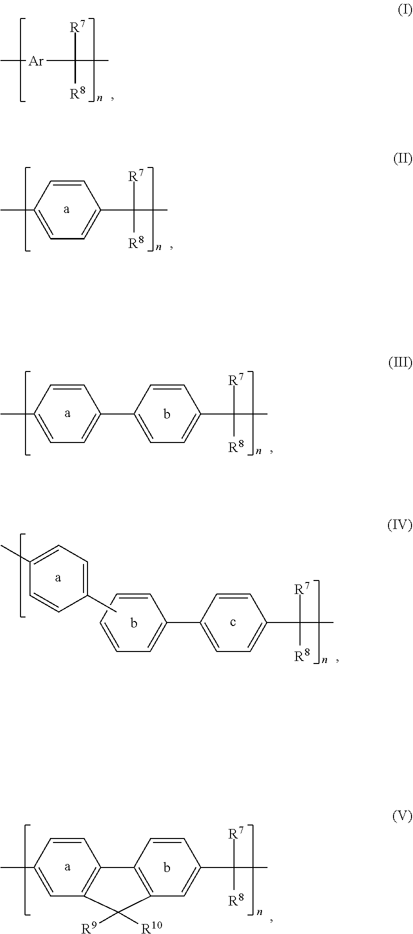

or a salt thereof, wherein: each of R⁷, R⁸, R⁹, and R¹⁰ is, independently, an electron-withdrawing moiety, H, optionally substituted aliphatic, alkyl, heteroaliphatic, heteroalkylene, aromatic, aryl, or arylalkylene, wherein at least one of R⁷ or R⁸ can include the electron-withdrawing moiety or wherein a combination of R⁷ and R⁸ or R⁹ and R¹⁰ can be taken together to form an optionally substituted cyclic group;
Ar comprises or is an optionally substituted aromatic or arylene (e.g., any described herein);
each of n is, independently, an integer of 1 or more;
each of rings a-c can be optionally substituted; and
rings a-c, R⁷, R⁸, R⁹, and R¹⁰ can optionally comprise an ionizable or ionic moiety.

Further non-limiting polymeric structures can include one or more of the following:

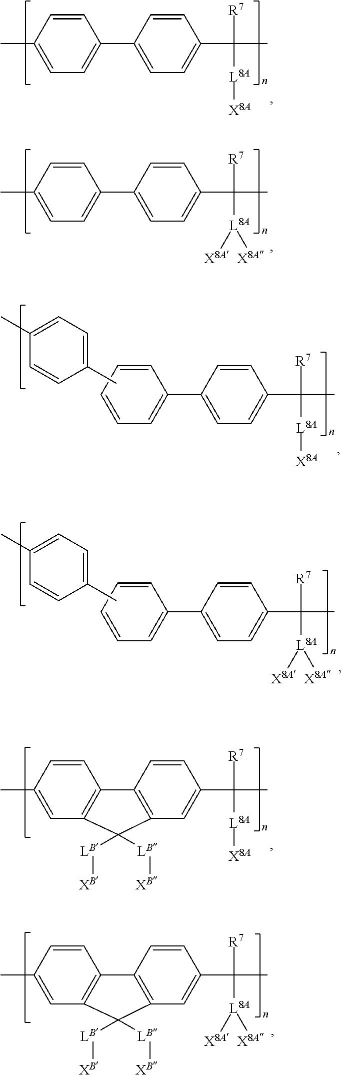

or a salt thereof, wherein:
R⁷ can be any described herein (e.g., for formulas (I)-(V));
n is from 1 or more;
each L^{8A}, L^{B′}, and L^{B″}is, independently, a linking moiety; and
each X^{8A}, X^{8A′}, X^{8A″}, X^{B′}, and X^{B″}is, independently, an ionizable or ionic moiety.

Yet other polymeric structures include the following:

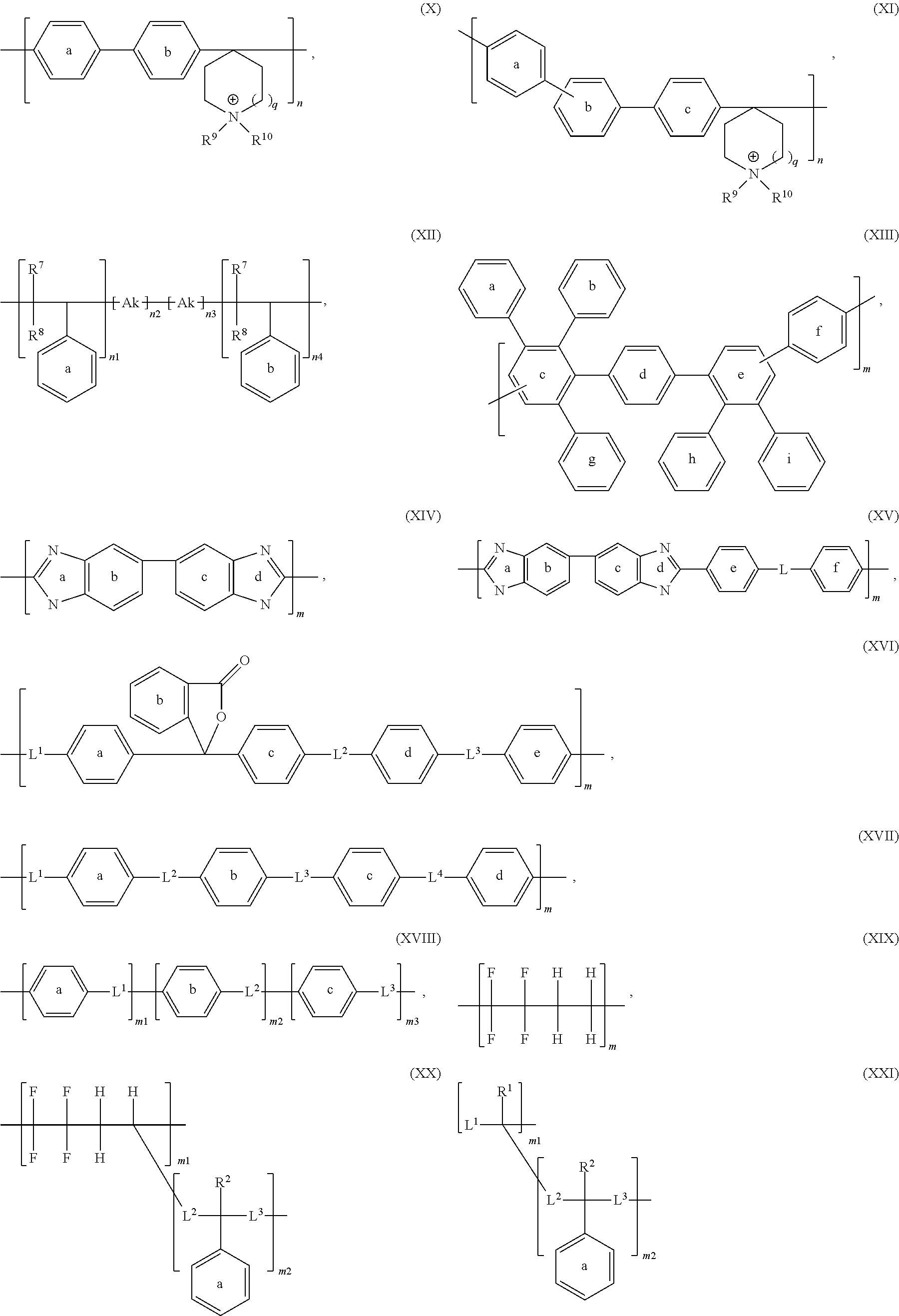

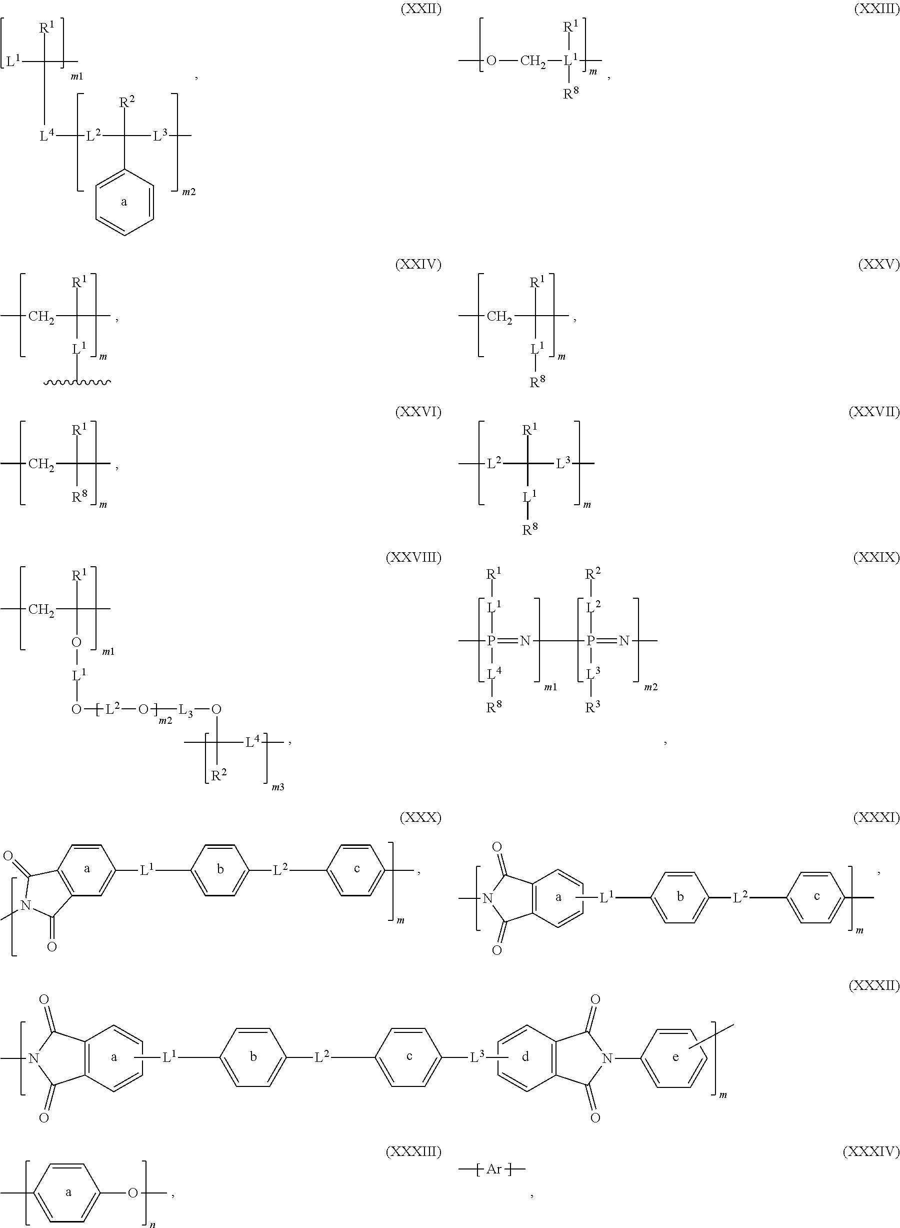

or a salt thereof, wherein:
each of R¹, R², R³, R⁷, R⁸, R⁹, and R¹⁰ is, independently, an electron-withdrawing moiety, H, optionally substituted aliphatic, alkyl, heteroaliphatic, heteroalkylene, aromatic, aryl, or arylalkylene, wherein at least one of R⁷ or R⁸ can include the electron-withdrawing moiety or wherein a combination of R⁷ and R⁸ or R⁹ and R¹⁰ can be taken together to form an optionally substituted cyclic group;
each Ak is or comprises an optionally substituted aliphatic, alkylene, haloalkylene, heteroaliphatic, or heteroalkylene;
each Ar is or comprises an optionally substituted arylene or aromatic;
each of L, L¹, L², L³, and L⁴ is, independently, a linking moiety;
each of n, n¹, n², n³, n⁴, m, m¹, m², and m³ is, independently, an integer of 1 or more;
q is 0, 1, 2, or more;
each of rings a-i can be optionally substituted; and
rings a-i, R⁷, R⁸, R⁹, and R¹⁰ can optionally include an ionizable or ionic moiety.

In particular embodiments (e.g., of formula (XIV) or (XV)), each of the nitrogen atoms on rings a and/or b are substituted with optionally substituted aliphatic, alkyl, aromatic, aryl, an ionizable moiety, or an ionic moiety. In some embodiments, one or more hydrogen or fluorine atoms (e.g., in formula (XIX) or (XX)) can be substituted to include an ionizable moiety or an ionic moiety (e.g., any described herein). In other embodiments, the oxygen atoms present in the polymeric structure (e.g., in formula XXVIII) can be associated with an alkali dopant (e.g., K⁺).

In particular examples, Ar, one or more of rings a-i (e.g., rings a, b, f, g, h, or i), L, L¹, L², L³, L⁴, Ak, R⁷, R⁸, R⁹, and/or R¹⁰ can be optionally substituted with one or more ionizable or ionic moieties and/or one or more electron-withdrawing groups. Yet other non-limiting substituents for Ar, rings (e.g., rings a-i), L, Ak, R⁷, R⁸, R⁹, and Rm include one or more described herein, such as cyano, hydroxy, nitro, and halo, as well as optionally substituted aliphatic, alkyl, alkoxy, alkoxyalkyl, amino, aminoalkyl, aryl, arylalkylene, aryloyl, aryloxy, arylalkoxy, hydroxyalkyl, and haloalkyl.

In some embodiments, each of R¹, R², and R³ is, independently, H, optionally substituted aromatic, aryl, aryloxy, or arylalkylene. In other embodiments (e.g., of formulas (I)-(V) or (XII)), R⁷ includes the electron-withdrawing moiety. In yet other embodiments, R⁸, R⁹, and/or R¹⁰ includes an ionizable or ionic moiety.

In one instance, a polymeric subunit can lack ionic moieties. Alternatively, the polymeric subunit can include an ionic moiety on the Ar group, the L group, both the Ar and L groups, or be integrated as part of the L group. Non-limiting examples of ionizable and ionic moieties include cationic, anionic, and multi-ionic group, as described herein.

In any embodiment herein, the electron-withdrawing moiety can include or be an optionally substituted haloalkyl, cyano (CN), phosphate (e.g., —O(P═O)(OR^{P1})(OR^{P2}) or —O—[P(═O)(OR^{P1})—O]_{P3}—R^{P2}), sulfate (e.g., —O—S(═O)₂(OR^{S1})), sulfonic acid (—SO₃H), sulfonyl (e.g., —SO₂—CF₃), difluoroboranyl (—BF₂), borono (B(OH)₂), thiocyanato (—SCN), or piperidinium. Yet other non-limiting phosphate groups can include derivatives of phosphoric acid, such as orthophosphoric acid, pyrophosphoric acid, tripolyphosphoric acid, tetrapolyphosphoric acid, trimetaphosphoric acid, and/or phosphoric anhydride, or combinations thereof.

Yet other polymeric units can include poly(benzimidazole) (PBI), polyphenylene (PP), polyimide (PI), poly(ethyleneimine) (PEI), sulfonated polyimide (SPI), polysulfone (PSF), sulfonated polysulfone (SPSF), poly(ether ketone) (PEEK), PEEK with cardo groups (PEEK-WC), polyethersulfone (PES), sulfonated polyethersulfone (SPES), sulfonated poly(ether ketone) (SPEEK), SPEEK with cardo groups (SPEEK-WC), poly(p-phenylene oxide) (PPO), sulfonated polyphenylene oxide (SPPO), ethylene tetrafluoroethylene (ETFE), polytetrafluoroethylene (PTFE), poly(epichlorohydrin) (PECH), poly(styrene) (PS), sulfonated poly(styrene) (SPS), hydrogenated poly(butadiene-styrene) (HPBS), styrene divinyl benzene copolymer (SDVB), styrene-ethylene-butylene-styrene (SEBS), sulfonated bisphenol-A-polysulfone (SPSU), poly(4-phenoxy benzoyl-1,4-phenylene) (PPBP), sulfonated poly(4-phenoxy benzoyl-1,4-phenylene) (SPPBP), poly(vinyl alcohol) (PVA), poly(phosphazene), poly(aryloxyphosphazene), polyetherimide, as well as combinations thereof.

### Bipolar MEA for COx Reduction

In certain embodiments, the MEA includes a bipolar interface having an anion-conducting polymer on the cathode side of the MEA and an interfacing cation-conducting polymer on the anode side of the MEA. In some implementations, the cathode contains a first catalyst and an anion-conducting polymer. In certain embodiments, the anode contains a second catalyst and a cation-conducting polymer. In some implementations, a cathode buffer layer, located between the cathode and PEM, contains an anion-conducting polymer. In some embodiments, an anode buffer layer, located between the anode and PEM, contains a cation-conducting polymer.

In embodiments employing an anion-conducting polymer in the cathode and/or in a cathode buffer layer, the MEA can decrease or block unwanted reactions that produce undesired products and decrease the overall efficiency of the cell. In embodiments employing a cation-conducting polymer in the anode and/or in an anode buffer layer can decrease or block unwanted reactions that reduce desired product production and reduce the overall efficiency of the cell.

For example, at levels of electrical potential used for cathodic reduction of CO₂, hydrogen ions may be reduced to hydrogen gas. This is a parasitic reaction; current that could be used to reduce CO₂ is used instead to reduce hydrogen ions. Hydrogen ions may be produced by various oxidation reactions performed at the anode in a CO₂ reduction reactor and may move across the MEA and reach the cathode where they can be reduced to produce hydrogen gas. The extent to which this parasitic reaction can proceed is a function of the concentration of hydrogen ions present at the cathode. Therefore, an MEA may employ an anion-conducting material in the cathode layer and/or in a cathode buffer layer. The anion-conducting material at least partially blocks hydrogen ions from reaching catalytic sites on the cathode. As a result, parasitic production of hydrogen gas decreases and the rate of production of CO or other carbon-containing product increases.

Another reaction that may be avoided is reaction of carbonate or bicarbonate ions at the anode to produce CO₂. Aqueous carbonate or bicarbonate ions may be produced from CO₂ at the cathode. If such ions reach the anode, they may react with hydrogen ions to produce and release gaseous CO₂. The result is net movement of CO₂ from the cathode to the anode, where it does not get reduced and is lost with oxidation products. To prevent the carbonate and bicarbonate ion produced at the cathode from reaching the anode, the anode and/or an anode buffer layer may include a cation-conducting polymer, which at least partially blocks the transport of negative ions such as bicarbonate ions to the anode.

Thus, in some designs, a bipolar membrane structure raises the pH at the cathode to facilitate CO₂ reduction while a cation-conducting polymer such as a proton-exchange layer prevents the passage of significant amounts of CO₂ and CO₂ reduction products (e.g., bicarbonate) to the anode side of the cell.

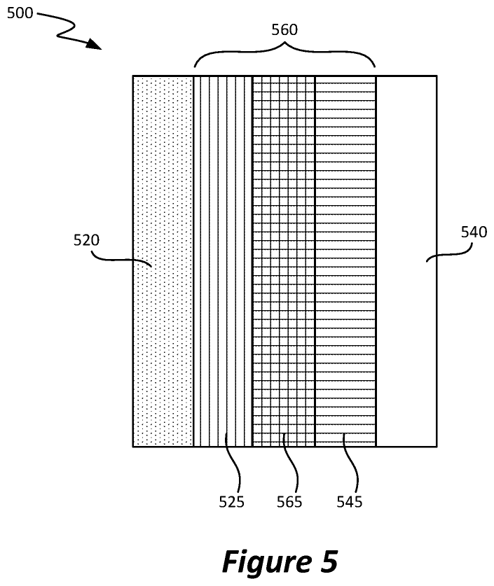

An example MEA 500 for use in COₓ reduction is shown in FIG. 5. The MEA 500 has a cathode layer 520 and an anode layer 540 separated by an ion-conducting polymer layer 560 that provides a path for ions to travel between the cathode layer 520 and the anode layer 540. In certain embodiments, the cathode layer 520 includes an anion-conducting polymer and/or the anode layer 540 includes a cation-conducting polymer. In certain embodiments, the cathode layer and/or the anode layer of the MEA are porous. The pores may facilitate gas and/or fluid transport and may increase the amount of catalyst surface area that is available for reaction.

The ion-conducting layer 560 may include two or three sublayers: a polymer electrolyte membrane (PEM) 565, an optional cathode buffer layer 525, and/or an optional anode buffer layer 545. One or more layers in the ion-conducting layer may be porous. In certain embodiments, at least one layer is nonporous so that reactants and products of the cathode cannot pass via gas and/or liquid transport to the anode and vice versa. In certain embodiments, the PEM layer 565 is nonporous. Example characteristics of anode buffer layers and cathode buffer layers are provided elsewhere herein. In certain embodiments, the ion-conducting layer includes only a single layer or two sublayers.

In some embodiments, a carbon oxide electrolyzer anode contains a blend of oxidation catalyst and an ion-conducting polymer. There are a variety of oxidation reactions that can occur at the anode depending on the reactant that is fed to the anode and the anode catalyst(s). In one arrangement, the oxidation catalyst is selected from the group consisting of metals and oxides of Ir, Pt, Ni, Ru, Pd, Au, and alloys thereof, IrRu, PtIr, Ni, NiFe, stainless steel, and combinations thereof. The oxidation catalyst can further contain conductive support particles such as carbon, boron-doped diamond, titanium, and any combination thereof.

As examples, the oxidation catalyst can be in the form of a structured mesh or can be in the form of particles. If the oxidation catalyst is in the form of particles, the particles can be supported by electronically conductive support particles. The conductive support particles can be nanoparticles. The conductive support particles may be compatible with the chemicals that are present in an electrolyzer anode when the electrolyzer is operating and are oxidatively stable so that they do not participate in any electrochemical reactions. It is especially useful if the conductive support particles are chosen with the voltage and the reactants at the anode in mind. In some arrangements, the conductive support particles are titanium, which is well-suited for high voltages. In other arrangements, the conductive support particles are carbon, which can be most useful at low voltages. In some embodiments, such conductive support particles are larger than the oxidation catalyst particles, and each conductive support particle can support one or more oxidation catalyst particles. In one arrangement, the oxidation catalyst is iridium ruthenium oxide. Examples of other materials that can be used for the oxidation catalyst include, but are not limited to, those listed above. It should be understood that many of these metal catalysts can be in the form of oxides, especially under reaction conditions.

As mentioned, in some embodiments, an anode layer of an MEA includes an ion-conducting polymer. In some cases, this polymer contains one or more covalently bound, negatively charged functional groups configured to transport mobile positively charged ions. Examples of the second ion-conducting polymer include ethanesulfonyl fluoride, 2-[1-[difluoro-[(trifluoroethenyl)oxy]methyl]-1,2,2,2-tetrafluoroethoxy]-1,1,2,2,-tetrafluoro-, with tetrafluoroethylene, tetrafluoroethylene-perfluoro-3,6-dioxa-4-methyl-7-octenesulfonic acid copolymer, other perfluorosulfonic acid polymers and blends thereof. Commercially available examples of cation-conducting polymers include e.g., Nafion 115, Nafion 117, and/or Nafion 211. Other examples of cationic conductive ionomers described above are suitable for use in anode layers.

There may be tradeoffs in choosing the amount of ion-conducting polymer in the anode. For example, an anode may include enough anode ion-conducting polymer to provide sufficient ionic conductivity, while being porous so that reactants and products can move through it easily. An anode may also be fabricated to maximize the amount of catalyst surface area that is available for reaction. In various arrangements, the ion-conducting polymer in the anode makes up about 10 and 90 wt %, or about 20 and 80 wt %, or about 25 and 70 wt % of the total anode mass. As an example, the ion-conducting polymer may make up about 5 and 20 wt % of the anode. In certain embodiments, the anode may be configured to tolerate relatively high voltages, such as voltages above about 1.2 V vs. a reversible hydrogen electrode. In some embodiments, an anode is porous in order to maximize the amount of catalyst surface area available for reaction and to facilitate gas and liquid transport.

In one example of a metal catalyst, Ir or IrOx particles (100-200 nm) and Nafion ionomer form a porous layer approximately 10 μm thick. Metal catalyst loading is approximately 0.5-3 g/cm². In some embodiments, NiFeOx is used for basic reactions.

In some embodiments, the MEA and/or the associated cathode layer is designed or configured to accommodate gas generated in situ. Such gas may be generated via various mechanisms. For example, carbon dioxide may be generated when carbonate or bicarbonate ions moving from the cathode toward the anode encounter hydrogen ions moving from the anode toward the cathode. This encounter may occur, for example, at the interface of anionic and cationic conductive ionomers in a bipolar MEA. Alternatively, or in addition, such contact may occur at the interface of a cathode layer and a polymer electrolyte membrane. For example, the polymer electrolyte membrane may contain a cationic conductive ionomer that allows transport of protons generated at the anode. The cathode layer may include an anion conductive ionomer.

Left unchecked, the generation of carbon dioxide or other gas may cause the MEA to delaminate or otherwise be damaged. It may also prevent a fraction of the reactant gas from being reduced at the anode.

The location within or adjacent to an MEA where a gas such as carbon dioxide is generated in situ may contain one or more structures designed to accommodate such gas and, optionally, prevent the gas from reaching the anode, where it would be otherwise unavailable to react.

In certain embodiments, pockets or voids are provided at a location where the gas is generated. These pockets or voids may have associated pathways that allow the generated gas to exit from the MEA, optionally to the cathode where, for example, carbon dioxide can be electrochemically reduced. In certain embodiments, an MEA includes discontinuities at an interface of anionic and cationic conductive ionomer layers such as at such interface in a bipolar MEA. In some embodiments, a cathode structure is constructed in a way that includes pores or voids that allow carbon dioxide generated at or proximate to the cathode to evacuate into the cathode.

In some embodiments, such discontinuities or void regions are prepared by fabricating in MEA in a way that separately fabricates anode and cathode structures, and then sandwiches to the two separately fabricated structures together in a way that produces the discontinuities or voids.

In some embodiments, and MEA structure is fabricated by depositing copper or other catalytic material onto a porous or fibrous matrix such as a fluorocarbon polymer and then coating the resulting structure with an anionic conductive ionomer. In some embodiments, the coated structure is then attached to the remaining MEA structure, which may include an anode and a polymer electrolyte membrane such as a cationic conductive membrane.

In some embodiments, a cathode has a porous structure and the/or an associated cathode buffer layer that has a porous structure. The pores may be present in an open cell format that allows generated carbon dioxide or other gas to find its way to the cathode.

In some MEAs, an interface between an anion conducting layer and a cation conducting layer (e.g., the interface of a cathode buffer layer and a PEM) includes a feature that resists delamination caused by carbon dioxide, water, or other material that may form at the interface. In some embodiments, the feature provides void space for the generated material to occupy until as it escapes from an MEA. In some examples, natural porosity of a layer such as an anion conducting layer provides the necessary void space. An interconnected network of pores may provide an escape route for carbon dioxide or other gas generated at the interface. In some embodiments, an MEA contains interlocking structures (physical or chemical) at the interface. In some embodiments, an MEA contains discontinuities at the interface. In some embodiments, an MEA contains of a fibrous structure in one layer adjacent the interface. A further discussion of interfacial structures between anion and cation conducting layers of MEAs is contained in Published PCT Application No. 2021/108446, published Jun. 3, 2021, and titled “MEMBRANE ELECTRODE ASSEMBLY FOR COₓ REDUCTION,” which is incorporated herein by reference in its entirety.

### Cathode Catalyst Layer

A primary function of the cathode catalyst layer is to provide a catalyst for COₓ reduction. An example reaction is:

CO₂+2H⁺+2e−→CO+H₂O.

The cathode catalyst layer may also have other functions that facilitate COₓ conversion. These include water management, gas transport, reactant delivery to the metal catalyst, product removal, stabilizing the particulate structure of the metal catalyst, electronic and ionic conduction to the metal catalyst, and mechanical stability within the MEA.

Certain functions and challenges are particular to carbon oxide electrolyzers and are not found in MEA assemblies for other applications such as fuel cells or water electrolyzers. These challenges include that the cathode catalyst layer of the MEA transports gas (e.g., CO₂ or CO) in and gas (e.g., ethylene, methane, CO) or liquid (e.g., ethanol) out. The cathode catalyst layer may be designed or configured to prevent accumulation of water that can block gas transport. Further, catalysts for COₓ reduction are sometimes less stable than catalysts like platinum that can be used in hydrogen fuel cells. These functions, their particular challenges, and how they can be addressed are described below.

### Water Management (Cathode Catalyst Layer)

The cathode catalyst layer facilitates movement of water to prevent it from being trapped in the cathode catalyst layer. Trapped water can hinder access of COₓ to the catalyst and/or hinder movement of reaction product out of the cathode catalyst layer.

Water management challenges are in many respects unique to COₓ electrolyzers. For example, compared to a PEM fuel cell's oxygen electrode, a COₓ electrolyzer uses a much lower gas flow rate. A COₓ electrolyzer also may use a lower flow rate to achieve a high utilization of the input COₓ. Vapor phase water removal is determined by the volumetric gas flow, thus much less vapor phase water removal is carried out in a COₓ electrolyzer. A COₓ electrolyzer may also operate at higher pressure (e.g.,100 psi-450 psi) than a fuel cell; at higher pressure the same molar flow results in lower volumetric flow and lower vapor phase water removal. For some MEAs, the ability to remove vapor phase water is further limited by temperature limits not present in fuel cells. For example, CO₂ to CO reduction may be performed at about 50° C. and ethylene and methane production may be performed at 20° C.-25° C. This is compared to typical operating temperatures of 80° C. to 120° C. for fuel cells. As a result, there is even more liquid phase water to remove.

Properties that affect ability of the cathode catalyst layer to remove water include porosity; pore size; distribution of pore sizes; hydrophobicity; the relative amounts of ion conducting polymer, metal catalyst particles, and electronically-conductive support; the thickness of the layer; the distribution of the catalyst throughout the layer; and the distribution of the ion conducting polymer through the layer and around the catalyst.

A porous layer allows an egress path for water. In some embodiments, the cathode catalyst layer has a pore size distribution that includes some pores having sizes of about 1 nm-100 nm and other pores having sizes of at least about 1 micron. This size distribution can aid in water removal. The porous structures could be formed by one or more of: pores within the carbon supporting structures (e.g., support particles); stacking pores between stacked carbon nanoparticles; secondary stacking pores between agglomerated carbon spheres (micrometer scale); or inert filler (e.g., PTFE) introduced pores with the interface between the PTFE and carbon also creating irregular pores ranging from hundreds of nm to micrometers.

The thickness of cathode catalyst layer may contribute to water management. Using a thicker layer allows the catalyst and thus the reaction to be distributed in a larger volume. This spreads out the water distribution and makes it easier to manage. In certain embodiments, the cathode layer thickness is about 80 nm-300 μm.

Ion-conducting polymers having non-polar, hydrophobic backbones may be used in the cathode catalyst layer. In some embodiments, the cathode catalyst layer may include a hydrophobic polymer such as PTFE in addition to the ion-conducting polymer. In some embodiments, the ion-conducting polymer may be a component of a co-polymer that also includes a hydrophobic polymer. In some embodiments, the ion-conducting polymer has hydrophobic and hydrophilic regions. The hydrophilic regions can support water movement and the hydrophobic regions can support gas movement.

### Gas Transport (Cathode Catalyst Layer)

The cathode catalyst layer is structured for gas transport. Specifically, COₓ is transported to the catalyst and gas phase reaction products (e.g., CO, ethylene, methane, etc.) is transported out of the catalyst layer.

Certain challenges associated with gas transport are unique to COₓ electrolyzers. Gas is transported both in and out of the cathode catalyst layer—COₓ in and products such as CO, ethylene, and methane out. In a PEM fuel cell, gas (O₂ or H₂) is transported in but nothing or product water comes out. And in a PEM water electrolyzer, water is the reactant with O₂ and H₂ gas products.

Operating conditions including pressures, temperature, and flow rate through the reactor affect the gas transport. Properties of the cathode catalyst layer that affect gas transport include porosity; pore size and distribution; layer thickness; and ionomer distribution. Example values of these parameters are provided elsewhere herein.

In some embodiments, the ionomer-catalyst contact is minimized. For example, the ionomer may form a continuous network along the surface of the carbon with minimal contact with the catalyst. The ionomer, support, and catalyst may be designed such that the ionomer has a higher affinity for the support surface than the catalyst surface. This can facilitate gas transport to and from the catalyst without being blocked by the ionomer, while allowing the ionomer to conduct ions to and from the catalyst.

### Ionorner (Cathode Catalyst Layer)

The ionomer may have multiple functions including holding particles of the catalyst layer together and allowing movement of ions through the cathode catalyst layer. In some cases, the interaction of the ionomer and the catalyst surface may create an environment favorable for COₓ reduction, increasing selectivity to a desired product and/or decreasing the voltage required for the reaction. Importantly, the ionomer is an ion-conducting polymer that allows the movement of ions through the cathode catalyst layer. Hydroxide, bicarbonate, and carbonate ions, for example, are moved away from the catalyst surface where the COₓ reduction occurs.

In certain embodiments, an ion-conducting polymer of a cathode comprises at least one ion-conducting polymer that is an anion-conductor. This can be advantageous because it raises the pH compared to a proton conductor.

Various anion-conducting polymers are described above. Many of these have aryl groups in their backbones. Such ionomers may be used in cathode catalyst layers as described herein. In some embodiments, an ion-conducting polymer can comprise one or more covalently bound, positively charged functional groups configured to transport mobile negatively charged ions. Examples of such ion-conducting polymers include aminated tetramethyl polyphenylene; poly(ethylene-co-tetrafluoroethylene)-based quaternary ammonium polymer; quaternized polysulfone), blends thereof, and/or any other suitable ion-conducting polymers. The first ion-conducting polymer can be configured to solubilize salts of bicarbonate or hydroxide.

In some embodiments, an ion-conducting polymer in a cathode comprises at least one ion-conducting polymer that is a cation and an anion-conductor. Examples of such ion-conducting polymer include polyethers that can transport cations and anions and polyesters that can transport cations and anions. Further examples of such ion-conducting polymer include polyethylene oxide, polyethylene glycol, polyvinylidene fluoride, and polyurethane.

During use in an electrolyzer, a cation and anion conductor may raise the local pH (compared to a pure cation conductor.) Further, in some embodiments, it may be advantageous to use a cation and anion conductor to promote acid base recombination in a larger volume instead of at a 2D interface of anion-conducting polymer and cation conducting polymer. This can spread out water and CO₂ formation, heat generation, and potentially lower the resistance of the membrane by decreasing the barrier to the acid-base reaction. All of these may be advantageous in helping avoid the buildup of products, heat, and lowering resistive losses in the MEA leading to a lower cell voltage.

In certain embodiments, an anion-conducting polymer has a polymer backbone with covalently bound positively charged functional groups appended. These may include positively charged nitrogen groups in some embodiments. In some embodiments, the polymer backbone is non-polar, as described above. The polymer may have any appropriate molecular weight, e.g., 25,000 g/mol-150,000 g/mol, though it will be understood that polymers outside this range may be used.

Challenges for ion-conducting polymers in COₓ electrolyzers include CO₂ dissolving in and/or solubilizing the polymers, making them less mechanically stable, prone to swelling, and allowing the polymer to move more freely. This makes the entire catalyst layer and polymer-electrolyte membrane less mechanically stable. In some embodiments, polymers that are not as susceptible to CO₂ plasticization are used. Also, unlike for water electrolyzers and fuel cells, conducting carbonate and bicarbonate ions is a key parameter for CO₂ reduction.

The introduction of polar functional groups, such as hydroxyl and carboxyl groups which can form hydrogen bonds, leads to pseudo-crosslinked network formation. Cross-linkers like ethylene glycol and aluminum acetylacetonate can be added to reinforce the anion exchange polymer layer and suppress polymer CO₂ plasticization. Additives like polydimethylsiloxane copolymer can also help mitigate CO₂ plasticization.

According to various embodiments, the ion-conducting polymer may have a bicarbonate ionic conductivity of at least 6 mS/cm, or in some embodiments at least 12 mS/cm, is chemically and mechanically stable at temperatures 80 oC and lower, and soluble in organic solvents used during fabrication such as methanol, ethanol, and isopropanol. The ion-conducting polymer is stable (chemically and has stable solubility) in the presence of the COₓ reduction products. The ion-conducting polymer may also be characterized by its ion exchange capacity, the total of active sites or functional groups responsible for ion exchange, which may range from 2.1 mmol/g-2.6 mmol/g in some embodiments. In some embodiments, ion-conducting polymers having lower IECs such as greater than 1 or 1.5 mmol/g may be used.

Examples of anion-conducting polymers are given above in above table as Class A ion-conducting polymers.

The as-received polymer may be prepared by exchanging the anion (e.g., I—, Br—, etc.) with bicarbonate.

Also, as indicated above, in certain embodiments the ionomer may be a cation-and-anion-conducting polymer. Examples are given in the above table as Class B ion-conducting polymers.

There are tradeoffs in choosing the amount of cation-conducting polymer in the cathode. A cathode may include enough cathode ion-conducting polymer to provide sufficient ionic conductivity but be sufficiently porous so that reactants and products can move through it easily and to maximize the amount of catalyst surface area that is available for reaction. In various arrangements, the cathode ion-conducting polymer makes up about 10 to 90 wt %, about 20 to 80 wt %, or about 30 to 70 wt % of the material in the cathode layer.

### Metal Catalyst (Cathode Catalyst Layer)

In certain embodiments, metal catalysts have one or more of the properties presented above. In general, a metal catalyst catalyzes one or more COₓ reduction reactions. The metal catalyst may be in the form of nanoparticles, but larger particles, films, and nanostructured surfaces may be used in some embodiments. The specific morphology of the nanoparticles may expose and stabilize active sites that have greater activity.

Examples of materials that can be used for the reduction catalyst particles include, but are not limited, to transition metals such as V, Cr, Mn, Fe, Co, Ni, Cu, Zr, Nb, Mo, Au, Ru, Rh, Pd, Ag, Cd, Hf, Ta, W, Re, Jr, Pt, and Hg, and combinations thereof, and/or any other suitable materials. Other catalyst materials can include alkali metals, alkaline earth metals, lanthanides, actinides, and post transition metals, such as Sn, Si, Ga, Pb, Al, Tl, Sb, Te, Bi, Sm, Tb, Ce, Nd and In or combinations thereof, and/or any other suitable catalyst materials. The choice of catalyst depends on the reaction performed at the cathode of the COₓ electrolyzer.

The metal catalyst may be composed of pure metals (e.g., Cu, Au, Ag), but alloys or bimetallic systems may be used for certain reactions. In some embodiments, a metal catalyst comprises a dopant. Examples of dopants include boron, nitrogen, and hydrogen. In some cases, the metal catalyst comprises boron-doped copper. The concentration of dopant may be substantially uniform throughout the metal particle or it may vary as a function of distance from particle surface. For example, the dopant concentration may decrease with distance from the particle surface.

The choice of catalyst may be guided by the desired reaction. For example, for CO production, Au may be used; for methane and ethylene production, Cu may be used. CO₂ reduction has a high overpotential compared to other well-known electrochemical reactions such as hydrogen evolution and oxygen evolution on known catalysts. Small amounts of contaminants can poison catalysts for CO₂ conversion.

Different metal catalyst materials may be chosen at least in part based on the desired product and MEA operation. For example, the 1D nanowire may have a higher selectivity for ethylene production while triangular Cu nanoplates may have higher selectivity for methane. Nanocubes may show good selectivity for ethylene in an AEM MEA.

### Support (Cathode Catalyst Layer)

As explained above, support structures may be particles. But more generally, they may have many different shapes such as spheres, polygons (e.g., triangles), nanotubes, and sheets (e.g., graphene)). Structures having high surface area to volume are useful to provide sites for catalyst particles to attach. Support structures may also be characterized by their porosity, surface area per volume, electrical conductivity, functional groups (N-doped, O-doped, etc), and the like. Various characteristics of particulate support structures are presented above.

If present, a support of the cathode catalyst particles may have any of various functions. It may stabilize metal nanoparticles to prevent them from agglomerating and distribute the catalytic sites throughout the catalyst layer volume to spread out loss of reactants and formation of products. A support may also provide an electrically conductive pathway to metal nanoparticles. Carbon particles, for example, pack together such that contacting carbon particles provide the electrically conductive pathway. Void space between the particles forms a porous network that gas and liquids can travel through.

The support may be hydrophobic and have affinity to the metal nanoparticle.

In many cases, the conductive support particles are compatible with the chemicals that are present in the cathode during operation, are reductively stable, and have a high hydrogen production overpotential so that they do not participate in any electrochemical reactions. In certain embodiments, conductive support particles are larger than the reduction catalyst particles, and each conductive support particle can support many reduction catalyst particles.

Examples of carbon blacks that can be used include:
Vulcan XC-72R- Density of 256 mg/cm², 30-50 nm
Ketjen Black- Hollow structure, Density of 100-120 mg/cm², 30-50 nm
Printex Carbon, 20-30 nm

### Properties of the Cathode Catalyst Layer

In certain embodiments, a cathode layer has a porosity of about 15 to 75%. Porosity of the cathode layer may be determined by various techniques. In one method, the loading of each component (e.g., catalyst, support, and polymer) is multiplied by its respective density. These are added together to determine the thickness the components take up in the material. This is then divided by the total known thickness to obtain the percentage of the layer that is occupied by the material. The resulting percentage is then subtracted from 1 to obtain the percentage of the layer assumed to be void space (e.g., filled with air or other gas or a vacuum), which is the porosity. In some embodiments, porosity is determined directly by a method such as mercury porosimetry or image analysis of TEM images.

The cathode layer may also be characterized by its roughness. The surface characteristics of the cathode layer can impact the resistances across the membrane electrode assembly. Excessively rough cathode layers can potentially lead to interfacial gaps between the catalyst and a current collectors or other electronically conductive support layer such as a microporous layer. These gaps hinder electron transfer from the current collector to the catalytic area, thus, increasing contact resistances. Interfacial gaps may also serve as locations for water accumulation that is detrimental to mass transport of reactants and products. On the other hand, extremely smooth surfaces may suffer from poor adhesion between layers. Cathode layer roughness may influence electrical contact resistances and concentration polarization losses. Surface roughness can be measured using different techniques (e.g. mechanical stylus method, optical profilometry, or atomic force microscopy) and is defined as the high-frequency, short wavelength component of a real surface. Arithmetic mean height, Sa, is a parameter that is commonly used to evaluate the surface roughness. Numerically, it is calculated by integrating the absolute height of valleys and peaks on the surface relative to the mean plane over the entire geometric area of the sample. Cathode layer Sa values between 0.50-1.10 μm or 0.70-0.90 μm may be used in some embodiments.

Examples of cathode catalyst layer characteristics for CO, methane, and ethylene/ethanol productions:
CO production: Au nanoparticles 4 nm in diameter supported on Vulcan XC72R carbon and mixed with TM1 anion exchange polymer electrolyte from Orion. Layer is about 15 μm thick, Au/(Au+C)=30%, TM1 to catalyst mass ratio of 0.32, mass loading of 1.4-1.6 mg/cm², estimated porosity of 0.47
Methane production: Cu nanoparticles of 20-30 nm size supported on Vulcan XC72R carbon, mixed with FAA-3 anion exchange solid polymer electrolyte from Fumatech. FAA-3 to catalyst mass ratio of 0.18. Estimated Cu nanoparticle loading of ˜7.1 μg/ cm², within a wider range of 1-100 μg/cm²
Ethylene/ethanol production: Cu nanoparticles of 25-80nm size, mixed with FAA-3 anion exchange solid polymer electrolyte from Fumatech. FAA-3 to catalyst mass ratio of 0.10. Deposited either on Sigracet 39BC GDE for pure AEM or onto the polymer-electrolyte membrane. Estimated Cu nanoparticle loading of 270 μg/cm².
Bipolar MEA for methane production: The catalyst ink is made up of 20 nm Cu nanoparticles supported by Vulcan carbon (Premetek 40% Cu/Vulcan XC-72) mixed with FAA-3 anion exchange solid polymer electrolyte (Fumatech), FAA-3 to catalyst mass ratio of 0.18. The cathode is formed by the ultrasonic spray deposition of the catalyst ink onto a bipolar membrane including FAA-3 anion exchange solid polymer electrolyte spray-coated on Nafion (PFSA) 212 (Fuel Cell Etc) membrane. The anode is composed of IrRuOx which is spray-coated onto the opposite side of the bipolar membrane, at a loading of 3 mg/cm². A porous carbon gas diffusion layer (Sigracet 39BB) is sandwiched to the Cu catalyst-coated bipolar membrane to compose the MEA.
Bipolar MEA for ethylene production: The catalyst ink is made up of pure 80 nm Cu nanoparticles (Sigma Aldrich) mixed with FAA-3 anion exchange solid polymer electrolyte (Fumatech), FAA-3 to catalyst mass ratio of 0.09. The cathode is formed by the ultrasonic spray deposition of the catalyst ink onto a bipolar membrane including FAA-3 anion exchange solid polymer electrolyte spray-coated on Nafion (PFSA) 115 (Fuel Cell Etc) membrane. The anode is composed of IrRuOx which is spray-coated onto the opposite side of the bipolar membrane, at a loading of 3 mg/cm². A porous carbon gas diffusion layer (Sigracet 39BB) is sandwiched to the Cu catalyst-coated bipolar membrane to compose the MEA.
CO production: Au nanoparticles 4 nm in diameter supported on Vulcan XC72R carbon and mixed with TM1 anion exchange polymer electrolyte from Orion. Layer is about 14 micron thick, Au/(Au+C)=20%. TM1 to catalyst mass ratio of 0.32, mass loading of 1.4-1.6 mg/cm², estimated porosity of 0.54 in the catalyst layer.
CO production: Au nanoparticles 45 nm in diameter supported on Vulcan XC72R carbon and mixed with TM1 anion exchange polymer electrolyte from Orion. Layer is about 11 micron thick, Au/(Au+C)=60%. TM1 to catalyst mass ratio of 0.16, mass loading of 1.1-1.5 mg/cm², estimated porosity of 0.41 in the catalyst layer.
CO production:: Au nanoparticles 4nm in diameter supported on Vulcan XC72R carbon and mixed with TM1 anion exchange polymer electrolyte from Orion. Layer is about 25 micron thick, Au/(Au+C)=20%. TM1 to catalyst mass ratio of 0.32, mass loading of 1.4-1.6 mg/cm², estimated porosity of 0.54 in the catalyst layer.

### PEM

MEAs may include a polymer electrolyte membrane (PEM) disposed between and conductively coupled to the anode catalyst layer and the cathode catalyst layer. In certain embodiments, a polymer electrolyte membrane has high ionic conductivity (e.g., greater than about 1 mS/cm) and is mechanically stable. Mechanical stability can be evidenced in a variety of ways such as through high tensile strength, modulus of elasticity, elongation to break, and tear resistance. Many commercially available membranes can be used for the polymer electrolyte membrane. Examples include, but are not limited to, various Nation® formulations, GORE-SELECT, FumaPEM® (PFSA) (FuMA-Tech GmbH), and Aquivion® (PFSA) (Solvay).

In one arrangement, the PEM comprises at least one ion-conducting polymer that is a cation-conductor. The third ion-conducting polymer can comprise one or more covalently-bound, negatively-charged functional groups configured to transport mobile positively-charged ions. The third ion-conducting polymer can be selected from the group consisting of ethanesulfonyl fluoride, 2-[1-[difluoro-[(trifluoroethenyl)oxy]methyl]-1,2,2,2-tetrafluoroethoxy]-1,1,2,2,-tetrafluoro-, with tetrafluoroethylene, tetrafluoroethylene-perfluoro-3,6-dioxa-4-methyl-7-octenesulfonic acid copolymer, other perfluorosulfonic acid polymers and blends thereof.

### Cathode Buffer Layer

When the polymer electrolyte membrane is a cation conductor (e.g., it conducts protons), it may contain a high concentration of protons during operation of the CRR, while a cathode may operate better when a low concentration of protons is present. A cathode buffer layer may be provided between the polymer electrolyte membrane and the cathode to provide a region of transition from a high concentration of protons to a low concentration of protons. In one arrangement, a cathode buffer layer is an ion-conducting polymer with many of the same properties as the ion-conducting polymer in the cathode. A cathode buffer layer may provide a region for the proton concentration to transition from a polymer electrolyte membrane, which has a high concentration of protons, to the cathode, which has a low proton concentration. Within the cathode buffer layer, protons from the polymer electrolyte membrane may encounter anions from the cathode, and they may neutralize one another. The cathode buffer layer may help ensure that a deleterious number of protons from the polymer electrolyte membrane does not reach the cathode and raise the proton concentration. If the proton concentration of the cathode is too high, COₓ reduction does not occur. A high proton concentration may be a concentration in the range of about 10 to 0.1 molar and low proton concentration may be a concentration of less than about 0.01 molar.

A cathode buffer layer can include a single polymer or multiple polymers. If the cathode buffer layer includes multiple polymers, the multiple polymers can be mixed together or can be arranged in separate, adjacent layers. Examples of materials that can be used for the cathode buffer layer include, but are not limited to, FumaSep FAA-3, Tokuyama anion exchange membrane material, and polyether-based polymers, such as polyethylene oxide (PEO), and blends thereof. Further examples are given above in the discussion of the cathode catalyst layer.

The thickness of the cathode buffer layer is chosen to be sufficient that COₓ reduction activity is high due to the proton concentration being low. This sufficiency can be different for different cathode buffer layer materials. In general, the thickness of the cathode buffer layer is between approximately 200 nm and 100 μm, between 300nm and 75 μm, between 500 nm and 50 μm, or any suitable range.

In some embodiments, the cathode buffer layer is less than 50 μm, for example between 1-25 μm such between 1-5 μm, 5-15 μm, or 10-25 μm. By using a cathode buffer layer in this range of thicknesses, the proton concentration in the cathode can be reduced while maintaining the overall conductivity of the cell. In some embodiments, an ultra-thin layer (100 nm-1 μm and in some embodiments, sub-micron) may be used. And as discussed above, in some embodiments, the MEA does not have a cathode buffer layer. In some such embodiments, anion-conducting polymer in the cathode catalyst layer is sufficient. The thickness of the cathode buffer layer may be characterized relative to that of the PEM.

Water and CO₂ formed at the interface of a cathode buffer layer and a PEM can delaminate the MEA where the polymer layers connect. The delamination problem can be addressed by employing a cathode buffer layer having inert filler particles and associated pores. One possible explanation of its effectiveness is that the pores create paths for the gaseous carbon dioxide to escape back to the cathode where it can be reduced.

Materials that are suitable as inert filler particles include, but are not limited to, TiO2, silica, PTFE, zirconia, and alumina. In various arrangements, the size of the inert filler particles is between 5 nm and 500 μm, between 10 nm and 100 μm, or any suitable size range. The particles may be generally spherical.

If PTFE (or other filler) volume is too high, it will dilute the polymer electrolyte to the point where ionic conductivity is low. Too much polymer electrolyte volume will dilute the PTFE to the point where it does not help with porosity. In many embodiments a mass ratio of polymer electrolyte/PTFE is 0.25 to 2, and more particularly, 0.5 to 1. A volume ratio polymer electrolyte/PTFE (or, more generally, polymer electrolyte/inert filler) may be 0.25 to 3, 0.5 to 2, 0.75 to 1.5, or 1.0 to 1.5.

In other arrangements, porosity is achieved by using particular processing methods when the layers are formed. One example of such a processing method is laser ablation, where nano to micro-sized channels are formed in the layers. Another example is mechanically puncturing a layer to form channels through it.

In one arrangement, the cathode buffer layer has a porosity between 0.01% and 95% (e.g., approximately between, by weight, by volume, by mass, etc.). However, in other arrangements, the cathode buffer layer can have any suitable porosity (e.g., between 0.01-95%, 0.01-75%, 1-95%, 1-90%). In some embodiments, the porosity is 50% or less, e.g., 0.1-50%, 5-50%, 20-50%, 5-40%, 10-40%, 20-40%, or 25%-40%. In some embodiments, the porosity is 20% or below, e.g. 0.1-20%, 1-10%, or 5-10%.

Porosity may be measured as described above with respect to the catalyst layer, including using mass loadings and thicknesses of the components, by methods such as mercury porosimetry, x-ray diffraction (SAXS or WAXS), and image processing on TEM images to calculate filled space vs. empty space. Porosity is measured when the MEA is completely dry as the materials swell to varying degrees when exposed to water during operation.

Porosity in layers of the MEA, including the cathode buffer layer, is described further below.

### Cathode Buffer Layer

When the polymer electrolyte membrane is a cation conductor (e.g., it conducts protons), it may contain a high concentration of protons during operation of the CRR, while a cathode may operate better when a low concentration of protons is present. A cathode buffer layer may be provided between the polymer electrolyte membrane and the cathode to provide a region of transition from a high concentration of protons to a low concentration of protons. In one arrangement, a cathode buffer layer is an ion-conducting polymer with many of the same properties as the ion-conducting polymer in the cathode. A cathode buffer layer may provide a region for the proton concentration to transition from a polymer electrolyte membrane, which has a high concentration of protons, to the cathode, which has a low proton concentration. Within the cathode buffer layer, protons from the polymer electrolyte membrane may encounter anions from the cathode, and they may neutralize one another. The cathode buffer layer may help ensure that a deleterious number of protons from the polymer electrolyte membrane does not reach the cathode and raise the proton concentration. If the proton concentration of the cathode is too high, COₓ reduction does not occur. A high proton concentration may be a concentration in the range of about to 0.1 molar and low proton concentration may be a concentration of less than about 0.01 molar.

A cathode buffer layer can include a single polymer or multiple polymers. If the cathode buffer layer includes multiple polymers, the multiple polymers can be mixed together or can be arranged in separate, adjacent layers. Examples of materials that can be used for the cathode buffer layer include, but are not limited to, FumaSep FAA-3, Tokuyama anion exchange membrane material, and polyether-based polymers, such as polyethylene oxide (PEO), and blends thereof. Further examples are given above in the discussion of the cathode catalyst layer.

The thickness of the cathode buffer layer is chosen to be sufficient that COₓ reduction activity is high due to the proton concentration being low. This sufficiency can be different for different cathode buffer layer materials. In general, the thickness of the cathode buffer layer is between approximately 200 nm and 100 μm, between 300 nm and 75 μm, between 500 nm and 50 μm, or any suitable range.

In some embodiments, the cathode buffer layer is less than 50 μm, for example between 1-25 μm such between 1-5 μm, 5-15 μm, or 10-25 μm. By using a cathode buffer layer in this range of thicknesses, the proton concentration in the cathode can be reduced while maintaining the overall conductivity of the cell. In some embodiments, an ultra-thin layer (100 nm-1 μm and in some embodiments, sub-micron) may be used. And as discussed above, in some embodiments, the MEA does not have a cathode buffer layer. In some such embodiments, anion-conducting polymer in the cathode catalyst layer is sufficient. The thickness of the cathode buffer layer may be characterized relative to that of the PEM.

Water and CO₂ formed at the interface of a cathode buffer layer and a PEM can delaminate the MEA where the polymer layers connect. The delamination problem can be addressed by employing a cathode buffer layer having inert filler particles and associated pores. One possible explanation of its effectiveness is that the pores create paths for the gaseous carbon dioxide to escape back to the cathode where it can be reduced.

Materials that are suitable as inert filler particles include, but are not limited to, TiO2, silica, PTFE, zirconia, and alumina. In various arrangements, the size of the inert filler particles is between 5 nm and 500 μm, between 10 nm and 100 μm, or any suitable size range. The particles may be generally spherical.

If PTFE (or other filler) volume is too high, it will dilute the polymer electrolyte to the point where ionic conductivity is low. Too much polymer electrolyte volume will dilute the PTFE to the point where it does not help with porosity. In many embodiments a mass ratio of polymer electrolyte/PTFE is 0.25 to 2, and more particularly, 0.5 to 1. A volume ratio polymer electrolyte/PTFE (or, more generally, polymer electrolyte/inert filler) may be 0.25 to 3, 0.5 to 2, to 1.5, or 1.0 to 1.5.

In other arrangements, porosity is achieved by using particular processing methods when the layers are formed. One example of such a processing method is laser ablation, where nano to micro-sized channels are formed in the layers. Another example is mechanically puncturing a layer to form channels through it.

In one arrangement, the cathode buffer layer has a porosity between 0.01% and 95% (e.g., approximately between, by weight, by volume, by mass, etc.). However, in other arrangements, the cathode buffer layer can have any suitable porosity (e.g., between 0.01-95%, 0.01-75%, 1-95%, 1-90%). In some embodiments, the porosity is 50% or less, e.g., 0.1-50%, 5-50%, 20-50%, 5-40%, 10-40%, 20-40%, or 25%-40%. In some embodiments, the porosity is 20% or below, e.g. 0.1-20%, 1-10%, or 5-10%.

Porosity may be measured as described above with respect to the catalyst layer, including using mass loadings and thicknesses of the components, by methods such as mercury porosimetry, x-ray diffraction (SAXS or WAXS), and image processing on TEM images to calculate filled space vs. empty space. Porosity is measured when the MEA is completely dry as the materials swell to varying degrees when exposed to water during operation.

Porosity in layers of the MEA, including the cathode buffer layer, is described further below.

### Anode Buffer Layer

In some CRR reactions, bicarbonate is produced at the cathode. It can be useful if there is a polymer that blocks bicarbonate transport somewhere between the cathode and the anode, to prevent migration of bicarbonate away from the cathode. It can be that bicarbonate takes some CO₂ with it as it migrates, which decreases the amount of CO₂ available for reaction at the cathode. In some MEAs, the polymer electrolyte membrane includes a polymer that blocks bicarbonate transport. Examples of such polymers include, but are not limited to, Nafion® formulations, GORE-SELECT, FumaPEM® (PFSA) (FuMA-Tech GmbH), and Aquivion® (PFSA) (Solvay). In some MEAs, there is an anode buffer layer between the polymer electrolyte membrane and the anode, which blocks transport of bicarbonate. If the polymer electrolyte membrane is an anion-conductor, or does not block bicarbonate transport, then an additional anode buffer layer to prevent bicarbonate transport can be useful. Materials that can be used to block bicarbonate transport include, but are not limited to Nafion® formulations, GORE-SELECT, FumaPEM® (PFSA) (FuMA-Tech GmbH), and Aquivion® (PFSA) (Solvay). Of course, including a bicarbonate blocking feature in the ion-exchange layer is not particularly desirable if there is no bicarbonate in the CRR.

In certain embodiments, an anode buffer layer provides a region for proton concentration to transition between the polymer electrolyte membrane to the anode. The concentration of protons in the polymer electrolyte membrane depends both on its composition and the ion it is conducting. For example, a Nafion polymer electrolyte membrane conducting protons has a high proton concentration. A FumaSep FAA-3 polymer electrolyte membrane conducting hydroxide has a low proton concentration. For example, if the desired proton concentration at the anode is more than 3 orders of magnitude different from the polymer electrolyte membrane, then an anode buffer layer can be useful to affect the transition from the proton concentration of the polymer electrolyte membrane to the desired proton concentration of the anode. The anode buffer layer can include a single polymer or multiple polymers. If the anode buffer layer includes multiple polymers, the multiple polymers can be mixed together or can be arranged in separate, adjacent layers. Materials that can be useful in providing a region for the pH transition include, but are not limited to, Nafion, FumaSep FAA-3, Sustainion®, Tokuyama anion exchange polymer, and polyether-based polymers, such as polyethylene oxide (PEO), blends thereof, and/or any other suitable materials. High proton concentration is considered to be in the range of approximately 10 to 0.1 molar and low concentration is considered to be less than approximately 0.01 molar. Ion-conducting polymers can be placed in different classes based on the type(s) of ions they conduct. This has been discussed in more detail above. There are three classes of ion-conducting polymers described in Table 1 above. In one embodiment of the invention, at least one of the ion-conducting polymers in the cathode, anode, polymer electrolyte membrane, cathode buffer layer, and anode buffer layer is from a class that is different from at least one of the others.

### Layer Porosity

It can be useful if some or all of the following layers are porous: the cathode, the cathode buffer layer, the anode and the anode buffer layer. In some arrangements, porosity is achieved by combining inert filler particles with the polymers in these layers. Materials that are suitable as inert filler particles include, but are not limited to, TiO2, silica, PTFE, zirconia, and alumina. In various arrangements, the size of the inert filler particles is between 5 nm and 500 μm, between 10 nm and 100 μm, or any suitable size range. In other arrangements, porosity is achieved by using particular processing methods when the layers are formed. One example of such a processing method is laser ablation, where nano to micro-sized channels are formed in the layers. Laser ablation can additionally or alternatively achieve porosity in a layer by subsurface ablation. Subsurface ablation can form voids within a layer, upon focusing the beam at a point within the layer, and thereby vaporizing the layer material in the vicinity of the point. This process can be repeated to form voids throughout the layer, and thereby achieving porosity in the layer. The volume of a void is preferably determined by the laser power (e.g., higher laser power corresponds to a greater void volume) but can additionally or alternatively be determined by the focal size of the beam, or any other suitable laser parameter. Another example is mechanically puncturing a layer to form channels through the layer. The porosity can have any suitable distribution in the layer (e.g., uniform, an increasing porosity gradient through the layer, a random porosity gradient, a decreasing porosity gradient through the layer, a periodic porosity, etc.).

The porosities (e.g., of the cathode buffer layer, of the anode buffer layer, of the membrane layer, of the cathode layer, of the anode layer, of other suitable layers, etc.) of the examples described above and other examples and variations preferably have a uniform distribution, but can additionally or alternatively have any suitable distribution (e.g., a randomized distribution, an increasing gradient of pore size through or across the layer, a decreasing gradient of pore size through or across the layer, etc.). The porosity can be formed by any suitable mechanism, such as inert filler particles (e.g., diamond particles, boron-doped diamond particles, polyvinylidene difluoride/PVDF particles, polytetrafluoroethylene/PTFE particles, etc.) and any other suitable mechanism for forming substantially non-reactive regions within a polymer layer. The inert filler particles can have any suitable size, such as a minimum of about 10 nanometers and a maximum of about 200 nanometers, and/or any other suitable dimension or distribution of dimensions.

As discussed above, the cathode buffer layer preferably has a porosity between about 1 and 90 percent by volume but can additionally or alternatively have any suitable porosity (including, e.g., no porosity). However, in other arrangements and examples, the cathode buffer layer can have any suitable porosity (e.g., between 0.01-95%, 0.1-95%, 0.01-75%, 1-95%, 1-90%, etc.). in some embodiments, the porosity is 20% or below, e.g. 0.1-20%, 1-10%, or 5-10%.

In some embodiments, the cathode buffer layer is porous but at least one layer between the cathode layer and the anode layer is nonporous. This can prevent the passage of gases and/or bulk liquid between the cathode and anode layers while still preventing delamination. For example, the nonporous layer can prevent the direct passage of water from the anode to the cathode.

### Other Embodiments and Conclusion

Although omitted for conciseness, embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

What is claimed is:

1. A system for utilizing excess electrical energy produced by an electrical network, the system comprising:
a carbon dioxide electrolyzer configured to electrochemically reduce carbon dioxide to a carbon dioxide reduction product;
a vessel configured to store the carbon dioxide reduction product; and
an energy conversion device configured to chemically convert the carbon dioxide reduction product and produce electrical energy,
wherein the system is further configured to supply electrical energy produced by the energy conversion device to the electrical network, and wherein the system is configured to provide electrical energy from the electrical network to the carbon dioxide electrolyzer.

2. The system of claim 1, further comprising a source of carbon dioxide coupled to the carbon dioxide electrolyzer.

3. The system of claim 2, wherein the source of carbon dioxide comprises a storage vessel configured to store carbon dioxide at a pressure greater than atmospheric pressure.

4. The system of claim 1, wherein the system is configured to transport carbon dioxide produced by the energy conversion device to a storage vessel for carbon dioxide.

5. The system of claim 1, wherein the energy conversion device comprises a combustion system.

6. The system of claim 1, wherein the energy conversion device comprises a fuel-cell configured to electrochemically convert the carbon dioxide reduction product and thereby produce the electrical energy.

7. The system of claim 1, wherein the carbon dioxide reduction product comprises carbon monoxide.

8. The system of claim 7, wherein the system is configured to combine hydrogen with the carbon monoxide and provide a mixture of carbon dioxide and hydrogen to the energy conversion device.

9. The system of claim 8, wherein the mixture of carbon dioxide and hydrogen is a syngas.

10. The system of claim 9, wherein the energy conversion device comprises a Fischer Tropsch reactor configured to convert the syngas to one or more liquid hydrocarbons.

11. The system of claim 10, further comprising a storage vessel for the liquid hydrocarbons.

12. A method of utilizing excess electrical energy produced by an electrical network, the method comprising:
receiving electrical energy from the electrical network and using the received electrical energy to electrochemically reduce carbon dioxide to a carbon dioxide reduction product;
storing the carbon dioxide reduction product in a vessel;
chemically converting the carbon dioxide reduction product and thereby producing electrical energy; and
supplying the produced electrical energy to the electrical network.

13. The method of claim 12, further comprising supplying the carbon dioxide from a source of carbon dioxide to the carbon dioxide electrolyzer.

14. The method of claim 13, wherein the source of carbon dioxide comprises a storage vessel configured to store carbon dioxide at a pressure greater than atmospheric pressure.

15. The method of claim 12, further comprising transporting carbon dioxide produced by chemically converting the carbon dioxide reduction product to a storage vessel for carbon dioxide.

16. The method of claim 12, wherein chemically converting the carbon dioxide reduction product comprises combusting the carbon dioxide reduction product.

17. The method of claim 12, wherein chemically converting the carbon dioxide reduction product comprises electrochemically converting the carbon dioxide reduction product in a fuel cell.

18. The method of claim 12, wherein the carbon dioxide reduction product comprises carbon monoxide.

19. The method of claim 18, further comprising combining hydrogen with the carbon monoxide and using a mixture of carbon dioxide and hydrogen when chemically converting the carbon dioxide reduction product.

20. The method of claim 19, wherein the mixture of carbon dioxide and hydrogen is a syngas.
